(19) United States
(12) Patent Application Publication
(10) Pub. No.: US 2023/0401792 A1
(43) Pub. Date: Dec. 14, 2023

(54) METHOD AND APPARATUS FOR APPROXIMATING BORDER(S) BETWEEN CLUSTERS OF GEOSPATIAL POINTS

(71) Applicant: HERE Global B.V., Eindhoven (NL)

(72) Inventor: Hilko HOFMANN, Schwalbach am Taunus (DE)

(21) Appl. No.: 17/836,691

(22) Filed: Jun. 9, 2022

(51) Int. Cl. G06T 17/20; G06F 16/29; G01C 21/34

(52) U.S. Cl. CPC G06T 17/20; G06F 16/29; G01C 21/34

(57) ABSTRACT

An approach is provided for approximating border(s) between clusters of geospatial points based on triangulation. The approach involves receiving geospatial points respectively associated with at least one of a plurality of codes representing an identifiable characteristic. The approach also involves tessellating the points to generate triangles. The approach further involves processing the triangles to determine triangle edge(s) that connects a first point associated with a first code set and a second point associated with a second code set. The approach further involves, for each of the determined triangle edge(s), adding a new point along the determined triangle edge and generating a new edge from the new point to a centroid of a respective triangle. The approach further involves determining a polygon based on the new edge. The polygon represents a border between the points associated with the first code set and the points associated with the second code set.

### BACKGROUND

Geospatial clustering is used to group a set of geospatial data points into groups/clusters which is an important function for mapping service providers to discover a relation between spatial attributes. The geospatial data points within a cluster usually show a high degree of similarity, whereas the clusters are as much dissimilar as possible. For instance, a pizza chain in a metro city wants to find out customer delivery orders distributions with respect to different franchises in the area, in order to re-draw the respective service areas which should change based on population, public services, infrastructure, housing, commerce development, etc. However, between some clusters of points are gaps without any geospatial points. For example, some park or farm lands are never associated with any pizza delivery orders. In this case, the exact borders/extend of a franchise area is undecided in view of the gaps. This problem extends, for example, to more generic logistics/delivery organizations. Accordingly, mapping service providers face significant technical challenges to automatically approximate the border between different clusters of geospatial data points.

### SOME EXAMPLE EMBODIMENTS

Therefore, there is a need for an approach for approximating border(s) between different areas/clusters of geospatial data points respectively associated with one of a plurality of codes representing an identifiable characteristic, such as postal code areas/clusters.

As used herein, the term “geospatial point” refers to a time-based data point that describes objects, events, phenomena, or other features related to a specific location (e.g., coordinates) on or near the surface of the earth. It can provide insights into relationships between variables and reveal patterns and trends. For instance, the location can be static in the short term (e.g., an address, the location of a piece of equipment, an earthquake event, a COVID positive patient, etc.) or dynamic (e.g., a moving vehicle or pedestrian, the spread of COVID, etc.). Although various embodiments are described with respect to postal code areas, it is contemplated that the approach described herein may be used with codes representing an identifiable characteristic, such as a delivery territory code, height-profile code, a crime rate code, an air-pollution code, a noise code, a school district code, a flood zone code, a zoning code, an aerial image code, a taxi rate zone code, a subway rate zone code, an electoral district code, etc.

According to one embodiment, a method comprises receiving a plurality of points of a point cloud. The points are geospatial points and are respectively associated with at least one code of a plurality of codes representing an identifiable characteristic. The method also comprises tessellating the plurality of points to generate a plurality of triangles. The method further comprises processing the plurality of triangles to determine one or more triangle edges that connect a first point associated with a first set of one or more codes of the plurality of codes and a second point associated with a second set of one or more codes of the plurality of codes. The first set is different from the second set. The method further comprises, for each of the one or more determined triangle edges, adding a new point along the one or more determined triangle edge and generating a new edge from the new point to a centroid of a respective triangle. The method further comprises determining a polygon based on the new edge generated for each of the one or more determined edges. The polygon represents a border between the plurality of points associated with the first set and the plurality of points associated with the second set. The method further comprises providing the polygon as an output.

According to another embodiment, an apparatus comprises at least one processor, and at least one memory including computer program code for one or more computer programs, the at least one memory and the computer program code configured to, with the at least one processor, cause, at least in part, the apparatus to receive a plurality of points of a point cloud. The points are geospatial points and are respectively associated with at least one code of a plurality of codes representing an identifiable characteristic. The apparatus is also caused to tessellate the plurality of points to generate a plurality of triangles. The apparatus is further caused to process the plurality of triangles to determine one or more triangle edges that connect a first point associated with a first set of one or more codes of the plurality of codes and a second point associated with a second set of one or more codes of the plurality of codes. The first set is different from the second set. The apparatus is further caused to, for each of the one or more determined triangle edges, add a new point along the one or more determined triangle edge and generating a new edge from the new point to a centroid of a respective triangle. The apparatus is further caused to determine a polygon based on the new edge generated for each of the one or more determined edges. The polygon represents a border between the plurality of points associated with the first set and the plurality of points associated with the second set. The apparatus is further caused to provide the polygon as an output.

According to another embodiment, a computer program product may be provided. For example, a computer program product comprising instructions which, when the program is executed by a computer, cause the computer to receive a plurality of points of a point cloud. The points are geospatial points and are respectively associated with at least one code of a plurality of codes representing an identifiable characteristic. The computer is also caused to tessellate the plurality of points to generate a plurality of triangles. The computer is further caused to process the plurality of triangles to determine one or more triangle edges that connect a first point associated with a first set of one or more codes of the plurality of codes and a second point associated with a second set of one or more codes of the plurality of codes. The first set is different from the second set. The computer is further caused to, for each of the one or more determined triangle edges, add a new point along the one or more determined triangle edge and generating a new edge from the new point to a centroid of a respective triangle. The computer is further caused to determine a polygon based on the new edge generated for each of the one or more determined edges. The polygon represents a border between the plurality of points associated with the first set and the plurality of points associated with the second set. The computer is further caused to provide the polygon as an output.

According to another embodiment, a non-transitory computer-readable storage medium carries one or more sequences of one or more instructions which, when executed by one or more processors, cause, at least in part, an apparatus to receive a plurality of points of a point cloud. The points are geospatial points and are respectively associated with at least one code of a plurality of codes representing an identifiable characteristic. The apparatus is also caused to tessellate the plurality of points to generate a plurality of triangles. The apparatus is further caused to process the plurality of triangles to determine one or more triangle edges that connect a first point associated with a first set of one or more codes of the plurality of codes and a second point associated with a second set of one or more codes of the plurality of codes. The first set is different from the second set. The apparatus is further caused to, for each of the one or more determined triangle edges, add a new point along the one or more determined triangle edge and generating a new edge from the new point to a centroid of a respective triangle. The apparatus is further caused to determine a polygon based on the new edge generated for each of the one or more determined edges. The polygon represents a border between the plurality of points associated with the first set and the plurality of points associated with the second set. The apparatus is further caused to provide the polygon as an output.

According to another embodiment, an apparatus comprises means for receiving a plurality of points of a point cloud. The points are geospatial points and are respectively associated with at least one code of a plurality of codes representing an identifiable characteristic. The apparatus also comprises means for tessellating the plurality of points to generate a plurality of triangles. The apparatus further comprises means for processing the plurality of triangles to determine one or more triangle edges that connect a first point associated with a first set of one or more codes of the plurality of codes and a second point associated with a second set of one or more codes of the plurality of codes. The first set is different from the second set. The apparatus further comprises means for adding a new point along the one or more determined triangle edge and generating a new edge from the new point to a centroid of a respective triangle, for each of the one or more determined triangle edges. The apparatus further comprises means for determining a polygon based on the new edge generated for each of the one or more determined edges. The polygon represents a border between the plurality of points associated with the first set and the plurality of points associated with the second set. The apparatus further comprises means for providing the polygon as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of approximating border(s) between clusters of geospatial points based on triangulation, according to example embodiment(s);

FIG. 2A is a diagram of example areas/clusters of geospatial data points, according to example embodiment(s);

FIG. 2B are diagrams of example geospatial data points respectively associated with one of a plurality of postal codes, according to example embodiment(s);

FIG. 2C is a diagram of an example flowchart for approximating border(s) between areas/clusters of postal code geospatial data points based on triangulation in zoom-in views, according to example embodiment(s);

FIG. 2D is a diagram of an example flowchart for approximating border(s) between areas/clusters of postal code geospatial data points based on triangulation in overhead views, according to example embodiment(s);

FIG. 2E is a diagram of an example multi-polygon of a synthetic/approximated postal code area in an overhead view, according to example embodiment(s);

FIG. 3 is a diagram of the components of a traffic platform configured to approximate border(s) between clusters of geospatial points based on triangulation, according to example embodiment(s);

FIG. 4 is a flowchart of a process for approximating border(s) between clusters of geospatial points based on triangulation, according to example embodiment(s);

FIGS. 5A-5G are example diagrams for approximating border(s) between areas/clusters of postal code geospatial data points based on triangulation, according to example embodiment(s);

FIGS. 6A and 6B are diagrams of example navigation user interfaces associated with an approximated border between postal codes, according to example embodiment(s);

FIG. 7 is a diagram of a geographic database, according to example embodiment(s);

FIG. 8 is a diagram of hardware that can be used to implement an embodiment;

FIG. 9 is a diagram of a chip set that can be used to implement an embodiment; and

FIG. 10 is a diagram of a mobile terminal (e.g., handset or vehicle or part thereof) that can be used to implement an embodiment.

### DESCRIPTION OF SOME EMBODIMENTS

Examples of a method, apparatus, and computer program for approximating border(s) between clusters of geospatial points based on triangulation are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

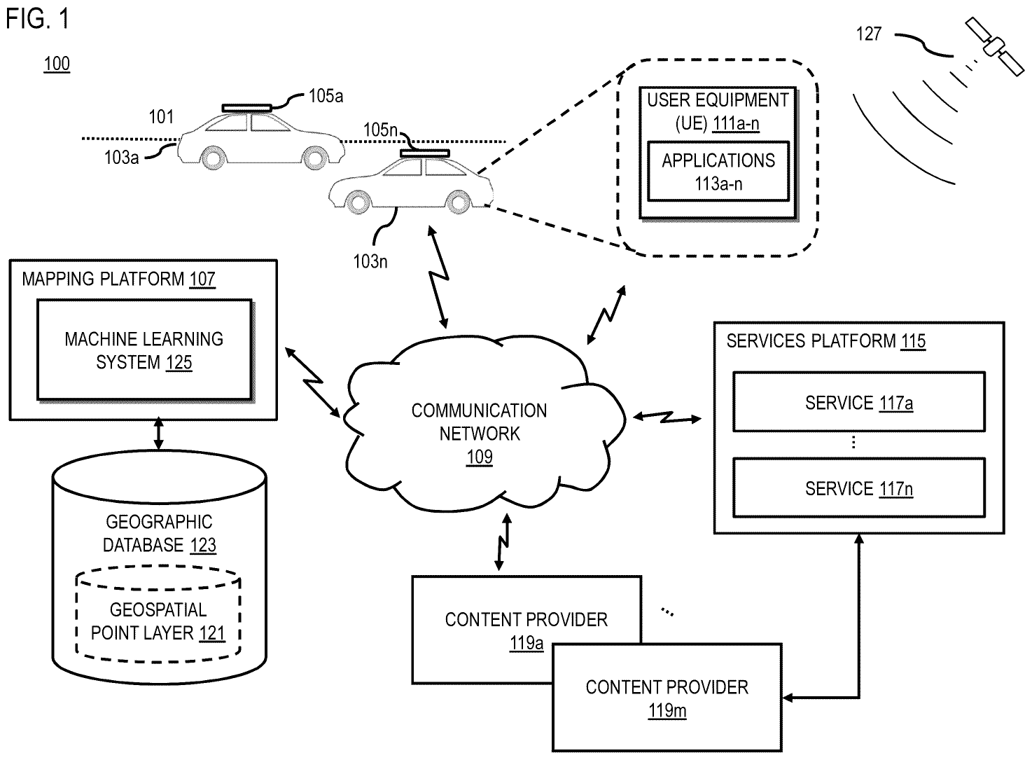

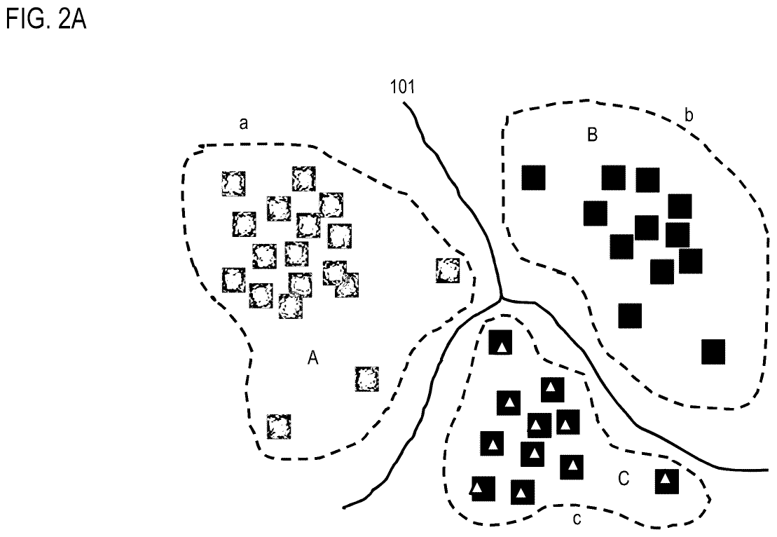

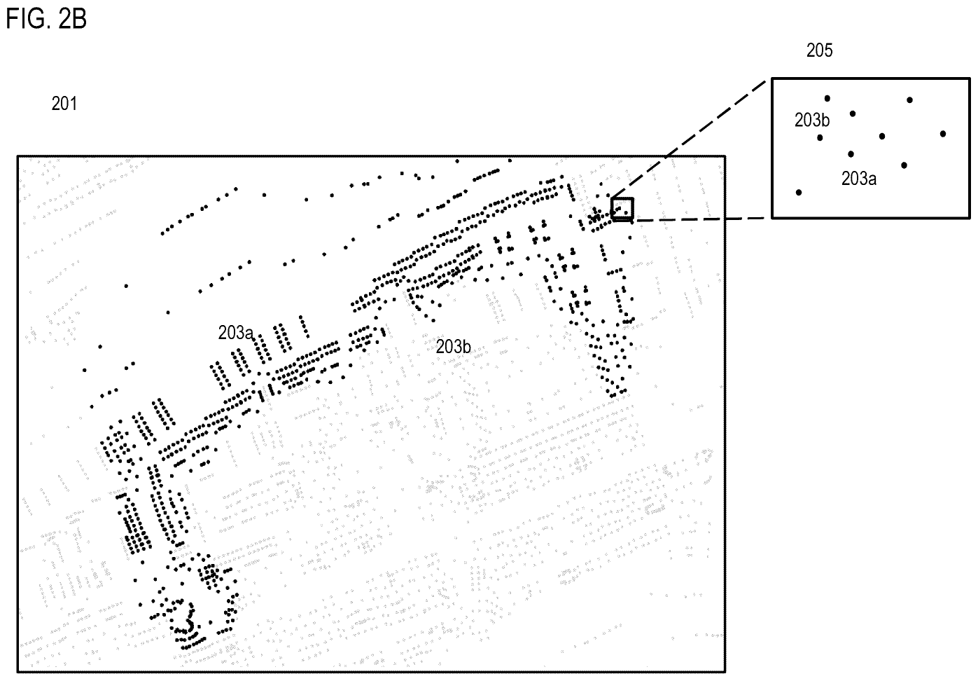

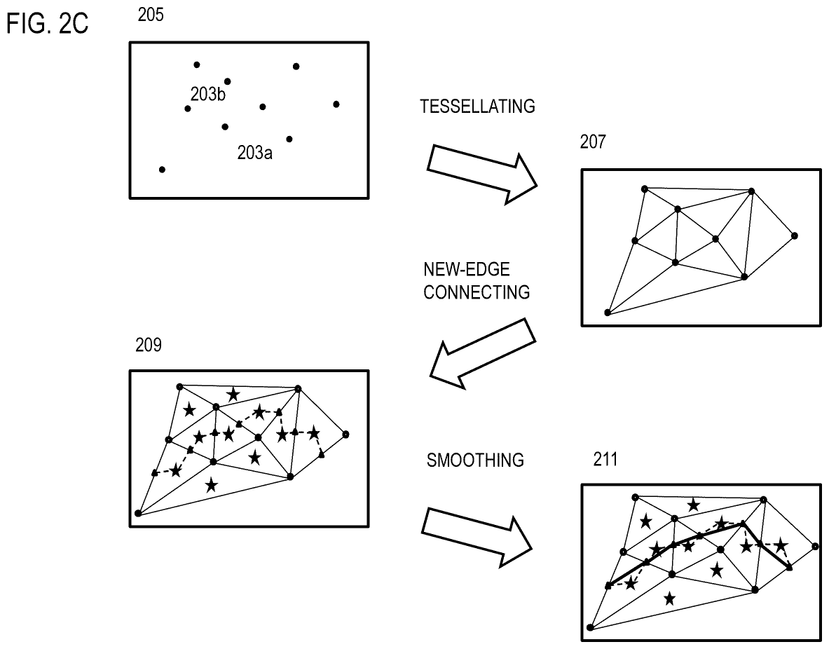

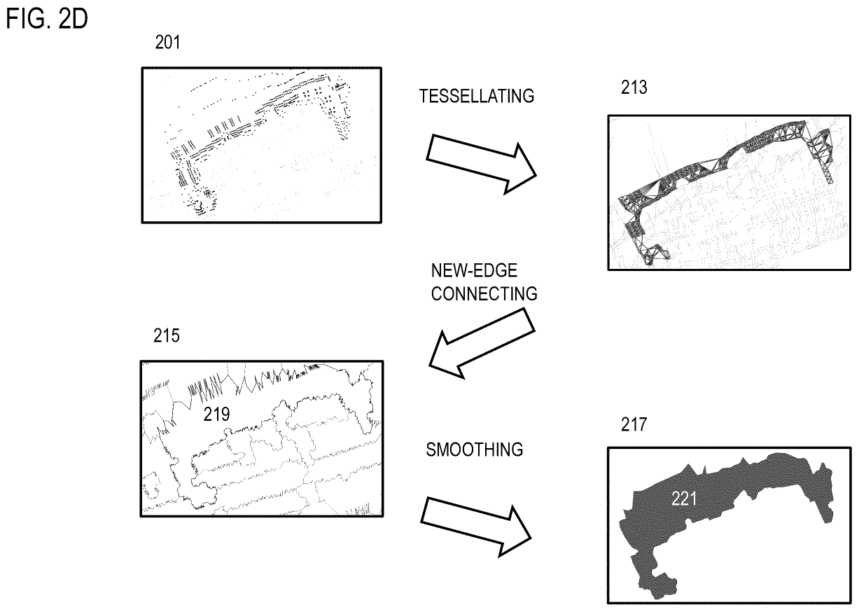

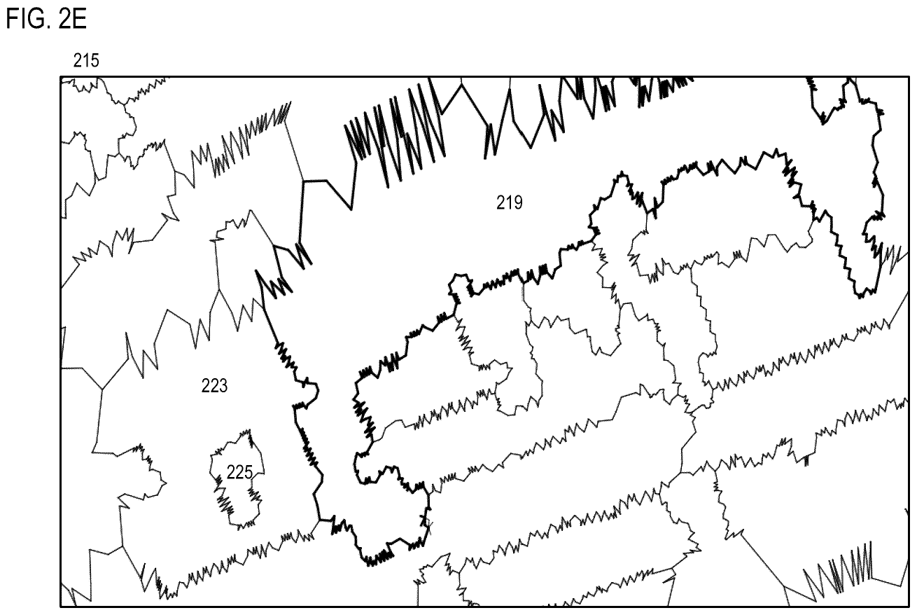

FIG. 1 is a diagram of a system capable of approximating border(s) between clusters of geospatial points based on triangulation, according to example embodiment(s). As mentioned above, a pizza chain in a metro city wants to find out customer delivery orders distributions with respect to different franchises in the area. FIG. 2A is a diagram of example areas/clusters of customer delivery orders, according to example embodiment(s). In this example, the delivery orders are roughly clustered into three clusters/groups A, B, C, with boundaries a, b, c without touching each other. In other words, in-between the clusters/groups A, B, C there are gaps without any geospatial points. Such pizza delivery border is often done in an arbitrary fashion. The polygons defining these areas over the map are not always accessible. For instance, some park or farm lands in the gaps are never associated with any pizza delivery orders. Geospatial points within the park other than a park entrance may have postal codes associated directly therewith; however, these geospatial points are not associated with a postal area definition directly, much less with a pizza delivery area. The problem is how to derive the corresponding area boundary from the point-based postal code information. In FIG. 2A, mapping service providers face significant technical challenges to automatically draw a border for the respective service areas for the three franchise stores without gaps in-between, which can be static, or dynamically change based on population, public services, infrastructure, housing, commerce development, etc.

To address these problems, a system 100 of FIG. 1 introduces a capability to automatically approximate border(s) between clusters of geospatial points based on triangulation. In one embodiment, the system 100 can collect the coordinates of geospatial points and their associated postal codes. FIG. 2B are diagrams of example geospatial data points respectively associated with one of a plurality of postal codes, according to example embodiment(s). A diagram 201 shows geospatial data points 203 including darkened geospatial data points 203a of a first postal code and the remaining geospatial data points 203b of other postal code(s). A zoom-in diagram 205 shows a small set of the geospatial data points 203 for border-approximating processing.

FIG. 2C is a diagram of an example flowchart for approximating border(s) between areas/clusters of postal code geospatial data points based on triangulation in zoom-in views, according to example embodiment(s). A polygon triangulation can subdivide a polygon into triangles. In a tessellating step, the system 100 can triangulate (e.g., using Delaunay triangulations, constrained Delaunay triangulations, the incremental insertion algorithms, etc.) geospatial data points 203a, 203b in the diagram 205 into triangles as in a diagram 207 irrespective of their postal codes. Delaunay triangulations can maximize the minimum angle of all the angles of the triangles in the triangulation. Each triangle is connected to a unique set of three points and contains no other point nor does it overlap another triangle. The three points may individually be part of other triangles but are never together part of another triangle.

In a new-edge connecting step, the system 100 can iterate over the triangles, determine triangle edges with end points of two different postal codes, and derive a new edge between an intermediate point of the determined triangle edge and a triangle centroid, and then connect the new edge into a rough border in a diagram 209 in FIG. 2C. For instance, the intermediate point can be a half-way point of the determined triangle edge.

FIG. 2D is a diagram of an example flowchart for approximating border(s) between areas/clusters of postal code geospatial data points based on triangulation in overhead views, according to example embodiment(s). Referring back to the diagram 201, after the tessellating step, the system 100 can triangulate geospatial data points 203a, 203b in the diagram 201 into triangles as in a diagram 213 in FIG. 2D irrespective of their postal codes. As shown in the diagram 213, darkened triangles are made from darkened geospatial data points 203a of the first postal code and other triangles are made from the remaining geospatial data points 203b of other postal code(s).

After the new-edge connecting step, the system 100 can iterate over the triangles in the diagram 213, determine triangle edges with end points of two different postal codes, and derive a new edge between an intermediate point of the determined triangle edge and a triangle centroid, and then connect the new edge into a rough border as a polygon 219 in a diagram 215 in FIG. 2D. As shown in the diagram 215, a darkened rough border is connected from darkened new edges of the first postal code and other rough borders are connected from other new edges of the other postal code(s). Referring back to FIG. 2C, an iteration over the rough border per postal code can create a polygon of a synthetic/approximated postal code area. In a smoothing step, the system 100 can smooth the rough border in the diagram 209 into a finer border in a diagram 211 in FIG. 2C (e.g., the border 101 in FIG. 2A), such as by connecting the intermediate points of the determined triangle edge without going via any triangle centroid. In one embodiment, in FIG. 2D, after the smoothing step, the darkened rough border in the diagram 215 is smoothed into the finer border and filled with black color in a diagram 217 to highlight the synthetic/approximated postal code area 221 of the first postal code. In another embodiment, the system 100 can use centroid points to avoid gaps in resulted areas, such as a multi-polygon in FIG. 2E. For instance, when an end point of the determined triangle edge at issue (i.e., an anchor point) belongs to three or more area-codes, the system 100 can choose a wrong turn and proceed into a dead end. In this case, the system 100 can use centroid points to form a border.

In another embodiment, the system 100 can build an area-code-map that stores lists of edges per area-code. In particular, the system 100 can iterate over the triangles. For each triangle, the system 100 can compute its centroid (and mark the point as centroid, so it is identifiable as a centroid-point) and iterate over the edges of the triangle (in the form of two consecutive-points). For each point of an edge, the system 100 can get a list of area-codes it belongs to, and compute an area-code-overlap-list of the area codes of the two consecutive-points. When the area-code-overlap-list is empty (for a connecting edge), the system 100 can compute a halfway-point between the two points, create a new edge connecting the centroid with the halfway-point, and add this new edge to the area-code-map for all area codes of the first point and the second point. When the area-code-overlap-list is not empty, (1) if the number of area-codes of the first point is greater than the overlap, the system 100 can add the edge from the first point to the centroid to the area-code-map for all area-codes of the area-code-overlap-list; or (2) if the number of area-codes of the second point is greater than the overlap, the system 100 can add the edge from the second point to the centroid to the area-code-map for all area-codes of the area-code-overlap-list. The system 100 can then ignore all edges that are considered interior edges, since they are irrelevant for finding the shared border between areas.

Tessellation refers to covering of a surface, often a plane, using one or more geometric shapes, called tiles, with no overlaps and no gaps. In our case, we are using triangles. Hereinafter, the term triangulation is used interchangeably with the term tessellation. The point of cloud is used as anker points for the tessellation algorithm. A point cloud refers to points of the input set independent of area-code from all areas. A halfway point refers to a point halfway between two points of an edge. A halfway point does not necessarily have to be exactly halfway. A halfway point can be used to find the border between two areas (defined by their area codes). Depending on contextual information, the halfway point may be better placed closer to one of the areas and farther away from the second point. A centroid refers to a geometric center of an triangle. In this context, the centroid can be a bridge point between two halfway-points. An edge refers to a set of two points forming a line of a triangle. An interior edge refers to an edge where the start and end coordinates have only one area code and it is the same area-code for both coordinates. A border edge refers to an edge where both coordinates of the edge belong to at least two area-codes and they share at least one of the area-codes. A connecting edge refers to an edge where both ends of the edge jointly belong to at least two area-codes but individually they may only belong to a single area-code. In other words, the ends of a connecting edge do not share an area code and thus connect two areas with different area codes.

In a tracing and assembling step, the system 100 can start with a random area-code from the keys in the area-code-map, and get the list of edges memorized for that area-code. The system 100 can then take a random edge (from the list of edges memorized for that area-code) and use a random coordinate from it and as anchor. The system 100 can add the other coordinate of the random edge to the coordinate-array (while preserving the order of the points) that will form the polygon of the area (for the current area-code).

The system 100 can search for the first edge that is connected to the anchor in the edge-list of the current area-code. If the anchor is not a centroid, the system 100 can add it to the coordinate-array, e.g., ignoring centroids since they may cause saw-like borders, except in some special cases to avoid gaps in resulted areas, such as the above-discussed multi-polygon example. The system 100 can use the non-anchor coordinate of the found edge as a new anchor and remove the current edge from the list of edges of this area-code (so it cannot be used again). The system 100 can go back to search for another edge connected to the anchor in the edge-list of the current area-code, until no edge is found for the current anchor.

When there are still edges left, the system 100 can check if the new edges being connected to each other by a single point can be looped (e.g., per area-code) into an individual polygon. If yes, the system 100 can add the loop as a polygon to the list of resulting polygons per area-code and proceed from the current anchor. In an implementation, the system 100 can use temporary lists that cache the order of elements. When no edge is left, the last edge non-anchor-coordinate should be identical with the first coordinate in the coordinate-array. In this case, the system 100 can add the last non-anchor-coordinate to the coordinate-array, which now is a polygon and is added to the list of polygons for the current area-code. The system 100 can then proceed the same process with a new area code.

In one embodiment, the system 100 can correct for holes (e.g., empty areas and overlaps), thereby producing a multi-polygon of a synthetic/approximated postal code area. For instance, the system 100 can add shells as a first LinearRing to a first polygon and holes as a second polygon, a third polygon, etc. FIG. 2E is the diagram 215 showing an example multi-polygon of a synthetic/approximated postal code area in an overhead view, according to example embodiment(s). The example multi-polygon includes a polygon 223 while excluding a hole polygon 225. For instance, the hole polygon 125 can belong to another area-code, and can be a part of another multi-polygon as a regular area. The system 100 can basically cut areas of one multi-polygon out of one or more other multi-polygons with which they overlap. Code wise, a hole polygon 125 can be just another area that is added to a polygon as a hole, and can be left out during rendering/presentation. This embodiment can be implemented via the java code listed in Table 1.

```
TABLE 1
package com.here.cme.cs.osm.compiler.util;
import java.util.ArrayList;
import java.util.Collection;
import java.util.HashMap;
import java.util.HashSet;
import java.util.LinkedList;
import java.util.List;
import java.util.Map;
import java.util.Map.Entry;
import java.util.Set;
import org.locationtech.jts.algorithm.Centroid;
import org.locationtech.jts.geom.Coordinate;
import org.locationtech.jts.geom.CoordinateSequence;
import org.locationtech.jts.geom.Geometry;
import org.locationtech.jts.geom.GeometryCollection;
import org.locationtech.jts.geom.LineString;
import org.locationtech.jts.geom.LinearRing;
import org.locationtech.jts.geom.MultiLineString;
import org.locationtech.jts.geom.MultiPoint;
import org.locationtech.jts.geom.MultiPolygon;
import org.locationtech.jts.geom.Point;
import org.locationtech.jts.geom.Polygon;
import org.locationtech.jts.triangulate.DelaunayTriangulationBuilder;
import org.slf4j.Logger;
import org.slf4j.LoggerFactory;
import com.here.cme.cs.osm.compiler.converter.ConverterConstant;
import com.here.cme.cs.osm.compiler.model.geojson.GeoJson;
import com.here.cme.cs.osm.compiler.processing.OsmPostalProcessor;
import com.here.cme.cs.osm.compiler.util.AreaCodeCompiler.CodeArea;
import com.here.momv2.mom.extension.osm.MomOsm;
import com.here.momv2.mom.feature.carto.Carto;
import com.here.momv2.mom.feature.carto.CartoProperties;
import com.here.momv2.mom.feature.feature.MomFeature;
import com.here.momv2.mom.feature.postal.Postal;
import com.here.momv2.mom.feature.postal.PostalProperties;
/**
  * Trinagulate's areas by code from a cloud of points to polygons that directly align to each
  * other.<br>
  * Each point gets assigned an area code. Each code will become an area during the
triangulation and
  * approximation process. In order for this to work properly, the code needs the surrounding
areas
  * too, because the areas define the borders to each other.
  */
public class AreaCodeCompiler
{
      public static class CodeArea<T extends Geometry>
      {
            public final String code;
            public final T area;
            public CodeArea( String code, T area )
            {
                  super( );
                  this.code= code;
                  this.area= area;
            }
      }
      protected static final Logger logger =
LoggerFactory.getLogger( AreaCodeCompiler.class );
      private final double CENTROID_Z = -
42.4242424242;
      /**
        * The points sorted by code
        */
      protected Map<Coordinate,List<String>> pointCloud = new
HashMap<Coordinate,List<String>>( );
      GeometryCollection polysCollection;
      /** The generated areas */
      protected List<CodeArea<MultiPolygon>> generatedAreas;
      /**
        * Clears the internal point cloud cache (reset to initial condition)
        */
      public void clear( )
      {
            pointCloud.clear( );
      }
      /**
        * Add an object directly with associated code
        *
        * @param geo
        *  The object
        * @param code
        *  The associated code
        */
      public void add( GeoJson geo, String code )
      {
            if( generatedAreas != null )
                  throw new IllegalStateException( ″Areas are already triangulated. Clear
first before adding new data.″ );
            if( code == null ∥ code.length( ) == 0 )
                  return;
            List <? > coords= geo.geometry.getCoordinates( );
            if( code.indexOf( ″;″ ) > 0 )
            {
                  String[ ] codes= code.split( ″;″ );
                  for( String c : codes )
                        collect( c, coords );
            }
            else
                  collect( code, coords );
      }
      private void collect( String code, List<?> list )
      {
            for( Object obj : list )
            {
                  if( obj instanceof List && ( (List<?>) obj ).get( 0 ) instanceof List )
                  {
                        collect( code, (List<?>) obj );
                  }
                  else if( obj instanceof Double )
                  {
                        p_collect( code, list );
                        return;
                  }
                  else
                  {
                        p_collect( code, (List<?>) obj );
                  }
            }
      }
      private void p_collect( String code, List<?> list )
      }
            @SuppressWarnings( ″unchecked″ )
            List<Double> dbls= (List<Double>) list;
            p_collect( code, new Coordinate( dbls.get( 0 ), dbls.get( 1 ) ) );
      }
      private void p_collect( String code, Coordinate c )
      {
            List<String> codes= pointCloud.get( c );
            if( codes == null )
                  pointCloud.put( c, codes= new ArrayList<String>( 2 ) );
            if( !codes.contains( code ) )
                  codes.add( code );
      }
      private GeometryCollection tessalatePointCloud( )
      {
            DelaunayTriangulationBuilder triangulator= new
DelaunayTriangulationBuilder( );
            // triangulator.setTolerance( 0.05 );
            triangulator.setSites( pointCloud.keySet( ) );
            return (GeometryCollection) triangulator.getTriangles(
OsmPostalProcessor. geometryFactory );
      }
      /**
        * Combines, tessalate's and assembles the data to a Postal object.<br>
        * If called more than once without calling clear( ) in between, no additional
triangulation will
        * happen after the first time. Method will only return the number of areas generated
        *
        * @param lazyMode
        *  If false, only valid polygons that have been properly assembled (closed)
get
        *  added. Else any polygon, valid or not, closed or not, gets added
        * @return Returns the number of areas generated. If zero is returned, nothing was
generated
        */
      public int compile( boolean lazyMode )
      {
            if( generatedAreas != null )
                  return generatedAreas.size( );
            polysCollection= tessalatePointCloud( );
            Map<String,List<Edge>> edges= new HashMap<String,List<Edge>>( );
            List<String> over= new ArrayList<String>( 4 );
            Coordinate c_0, c_1, cen;
            Coordinate[ ] coords;
            Polygon px;
            List<String> c0Codes, c1Codes;
            for( int i= 0; i < polysCollection.getNumGeometries( ); i++ )
            {
                  px= (Polygon) polysCollection.getGeometryN( i );
                  cen= Centroid.getCentroid( px );
                  // Mark as Centroid
                  cen.z= CENTROID_Z;
                  coords= px.getCoordinates( );
                  c0Codes= pointCloud.get( c_0= coords[0] );
                  for( int k= 1; k < coords.length; k++ )
                  {
                        c1Codes= pointCloud.get( c_1= coords[k] );
                        overlap( c0Codes, c1Codes, over );
                        switch( over.size( ) )
                        {
                              case 0:
                                    addEdge( split( c_0, c_1 ), cen, c0Codes,
c1Codes, edges );
                              break;
                              default:
                              {
                                    if( c0Codes.size( ) > over.size( ) )
                                          addEdge( c_0, cen, over, null, edges );
                                    if( c1Codes.size( ) > over.size( ) )
                                          addEdge( c_1, cen, over, null, edges );
                              }
                              break;
                        }
                        c_0= c_1;
                        c0Codes= c1Codes;
                  }
            }
            ArrayList<Coordinate> polyline= new ArrayList<Coordinate>( );
            ArrayList<Shell> rings= new ArrayList<Shell>( );
            AnchorStack anchorStack= new AnchorStack( 1000 );
            for( String code : edges.keySet( ) )
            {
                  List<Edge> edgeList= edges.get( code );
                  // The anchor we trace along the outer border of an code-area
                  Coordinate anchor= null;
                  Coordinate start= null;
                  int anchorCodeCount= 0;
                  while( edgeList.size( ) > 0 )
                  {
                        anchorStack.clear( );
                        Edge edge= edgeList.remove( 0 );
                        // We use a temporary edge list in order to test if the start
condition actually
                        // leads to a useful polygon.
                        // Since we remove used edges, it can happen that the start-edge
was ill chosen
                        // and leads to a destruction of the list, so that even
                        // if a good edge is used next, it is no longer possible to assemble
the
                        // polygon.
                        List<Edge> tempEdgeList= new ArrayList<Edge>( edgeList );
                        polyline.add( norm( start= edge.start ) );
                        anchorCodeCount= getAnchorCodeCount( anchor= edge.end );
                        boolean closed= false;
                        while( anchor != null )
                        {
                              anchorStack.remove( );
                              for( int k= 0; k < tempEdgeList.size( ); k++ )
                              {
```

| | |
|---|---|
| | Edge edgeK= tempEdgeList.get( k ); |
| | boolean equalsStart= edgeK.start.equals2D( |
| anchor ); | |
| | if( equalsStart ∥ edgeK.end.equals2D( anchor ) ) |
| | { |
| | // Do not use centroid points except |
| special cases! | |
| | // centroid points generate a very uneven |
| border with lots of very sharp angled | |
| | // spikes like the edge of a saw. |
| | // In order to avoid that, we only use them |
| in a special case where it is | |
| | // surrounded by 3 or more codes. |
| | // In that case we would get a lot of |
| triangular shaped holes in the data if we | |
| | // did not add it! |
| | if( anchor.z != CENTROID_Z ∥ |
| anchorCodeCount > 2 ) | |
| | { |
| | // Special case: Shared point |
| | // The polygon is actually two or |
| more polygons that sometimes share only a | |
| | // single point (they touch each |
| other at a single point). | |
| | // We have to split the polygons |
| up, else the geometry will be screwed up. | |
| | // INFO: |
| | // We collected another polygon |
| that only touched our current one. | |
| | // We basically made the wrong |

turn, took a loop and came back to the original

| | |
|---|---|
| | // turn. |
| | // Now we extract this loop from |
| the polygon and add it as separate polygon. | |
| | // Then we proceed with the |
| anchor of the wrong-turn-point | |
| | int idx= polyline.indexOf( anchor |
| ); | |
| | if( idx >= 0 ) |
| | { |
| | // In order to be a valid |
| polygon it must have at least 3 points | |
| | // (in this context we do not |

use the closing point yet. It will be added at the

| | |
|---|---|
| | // end) |
| | if( polyline.size( ) - idx > 2 |
| ) | |
| | { |
| | List<Coordinate> |

virtualSubList= polyline.subList( idx, polyline.size( ) );

List<Coordinate>

realSubList= new ArrayList<Coordinate>( virtualSubList );

| | |
|---|---|
| | realSubList.add( |
| norm( anchor ) ); | |
| | rings.add( new |
| Shell( realSubList ) ); | |
| | edgeList= |
| tempEdgeList; | |
| | } |
| | // Remove the points |
| | for( int r= polyline.size( ) - |
| 1; r > idx; r-- ) | |
| | polyline.remove( r |
| ); | |
| | } |
| | else |
| | polyline.add( norm( anchor |
| ) ); | |
| | } |
| | anchorStack.add( anchor, |
| anchorCodeCount ); | |
| | anchor= equalsStart ? edgeK.end : |
| edgeK.start; | |
| | anchorCodeCount= |
| getAnchorCodeCount( anchor ); | |
| | tempEdgeList.remove( e ); |
| | // Start again from zero |
| | k = -1; |
| | } |
| } | |

```
                              Anchor lastAnchor= anchorStack.get( );
                              if( lastAnchor != null )
```

| | |
|---|---|
| { | |
| | if( anchor. equals2D( start ) ) |
| | { |
| | // Make sure we only add if closed |
| | closed= polyline.size( ) > 2; |
| | break; |
| | } |
| | if( polyline.size( ) > 0 ) |
| | { |
| | int last= polyline. size( ) - 1; |
| | Coordinate cx= polyline.get( last ); |
| | // Remove last anchor, since it did lead to |
| a dead-end. | |
| | // It will be added again if one of the other |
| edges, it is connected to, is not | |
| | // a dead-end! |
| | if( cx.equals2D( lastAnchor.anchor ) ) |
| | polyline.remove( last ); |
| | } |
| | anchor= lastAnchor.anchor; |
| | anchorCodeCount= lastAnchor.count; |
| } | |
| else | |
| { | |
| | anchor= null; |
| | anchorCodeCount= 0; |
| } | |
| } | |

```
/ // OA measure: If we hit the start coordinate again, we did make
a full loop,
                        // and it is very likely that the resulting LinearRing is a valid
geometry.
                        if( ( lazyMode ∥ closed ) && polyline.size( ) > 2 )
```

{

if( !start.equals2D( polyline.get( 0 ) ) )

logger.warn( ″Start != polyline[0]″ );

```
                              // Close the LinearRing
                              polyline.add( polyline.get( 0 ) );
                              rings.add( new Shell( polyline ) );
                              polyline= new ArrayList<Coordinate>( );
                              // The star-edge was chosen well, we can use the
tempEdgeList further
                              edgeList= tempEdgeList;
                        }
                        polyline.clear( );
                  }
                  MultiPolygon multi= toMultiPolygon( rings, lazyMode );
                  if( multi != null )
                        addArea( code, multi );
                  rings.clear( );
            }
            return ( generatedAreas == null ) ? 0 : generatedAreas.size( );
      }
      protected void addArea( String code, MultiPolygon area )
      {
            if( generatedAreas == null )
                  generatedAreas= new LinkedList<CodeArea<MultiPolygon>>( );
            generatedAreas.add( new CodeArea<MultiPolygon>( ″A-″ + code, area ) );
      }
      private Coordinate norm( Coordinate anchor )
      {
            return ( anchor.z == CENTROID_Z) ? new Coordinate( anchor.x, anchor.y, 0 )
: anchor;
      }
      private int getAnchorCodeCount( Coordinate anchor )
      {
            List<String> anchorCodes= pointCloud.get( anchor );
            return ( anchorCodes == null ) ? 0 : anchorCodes. size( );
      }
      public void addEdge( Coordinate c01, Coordinate cen, List<String> c0Codes,
List<String> c1Codes, Map<String,List<Edge>> edges )
      {
            for( String code : c0Codes )
                  p_collect( code, cen );
            Edge me= new Edge( c01, cen );
            addEdge( me, c0Codes, edges );
            addEdge( me, c1Codes, edges );
      }
      public void addEdge( Edge me, List<String> codes, Map<String,List<Edge>> edges )
      {
            if( codes != null )
                  for( String code : codes )
                  {
                        List<Edge> edgeList= edges.get( code );
                        if( edgeList == null )
                              edges.put( code, edgeList= new ArrayList<Edge>( 50 ) );
                        boolean add= true;
                        for( Edge x : edgeList )
                              if( ( x.start.equals2D( me.start ) && x.end.equals2D(
me.end ) ) ∥ x.end.equals2D( me.start ) && x.start.equals2D( me.end ) )
                              {
                                    add= false;
                                    break;
                              }
                        if( add )
                              edgeList.add( me );
                  }
      }
      private MultiLineString toMultiLineString( List<Edge> edgeList )
      {
            List<LineString> list= new ArrayList<LineString>( edgeList.size( ) );
            for( Edge e : edgeList )
            {
                  Coordinate[ ] coords= new Coordinate[ ] { e.start, e.end };
                  CoordinateSequence coordSeq=
OsmPostalProcessor.geometryFactory.getCoordinateSequenceFactory( ).create( coords );
                  LineString ls= new LineString( coordSeq,
OsmPostalProcessor.geometryFactory );
                  list.add( ls );
            }
            LineString[ ] ls= list.toArray( new LineString[list.size( )] );
            return new MultiLineString( ls, OsmPostalProcessor.geometryFactory );
      }
      /**
        * Combines the LinearRing's to shells and holes of a Polygon
        */
      protected MultiPolygon toMultiPolygon( List<Shell> shells, boolean lazyMode )
      {
            for( int i= 0; i < shells.size( ); i++ )
            {
                  Shell hole= shells.get( i );
                  for( int k= 0; k < shells. size( ); k++ )
                  {
                        if(i == k )
                              continue;
                        Shell cover= shells.get( k );
                        if( OsmGeoUtil.isInsidePolygon( hole.shell, cover.shell ) )
                        {
                              cover.addHole( hole.shell );
                              shells.remove( i );
                              i--;
                              break;
                        }
                  }
            }
            List<Polygon> polygons= new ArrayList<Polygon>( );
            for( Shell shell : shells )
            {
                  Polygon poly= new Polygon( shell.getShellAsLinearRing( ),
shell.getHolesAsLinearRings( lazyMode ), OsmPostalProcessor.geometryFactory );
                  if( lazyMode ∥ poly.isValid( ) )
                        polygons.add( poly );
            }
            return ( polygons.size( ) == 0 ) ? null : new MultiPolygon( polygons.toArray(
new Polygon[polygons.size( )] ), OsmPostalProcessor.geometryFactory );
      }
      protected static Coordinate split( Coordinate c0, Coordinate c1 )
      {
            return new Coordinate( 0.5 * ( c0.x + c1.x), 0.5 * ( c0.y + c1.y ), 0 );
      }
      protected static void overlap( Collection<String> cache0, Collection<String> cache1,
List<String> over )
      {
            over.clear( );
            for( String code0 : cache0 )
                  if( cache1.contains( code0 ) )
                        over.add( code0 );
      }
}
class Edge
{
      public final Coordinate start;
      public final Coordinate end;
      public Edge( Coordinate start, Coordinate end )
      {
            this.start= start;
            this.end= end;
      }
}
class Anchor
{
      public int count;
      public Coordinate anchor;
}
class AnchorStack
{
      private final Anchor[ ] anchors;
      private int idx = -1;
      private int fill;
      public AnchorStack( int capacity )
      {
            anchors= new Anchor[capacity];
            for( int i= 0; i < capacity; i++ )
                  anchors[i]= new Anchor( );
      }
      /**
        * Resets the stack / empties the stack
        */
      public void clear( )
      {
            idx= -1;
            fill= 0;
      }
      /**
        * Adds an entry to the top of the stack
        */
      public void add( Coordinate anchor, int count )
      {
            int i= ++idx % anchors.length;
            anchors[i].anchor= anchor;
            anchors[i].count= count;
            if( fill < anchors.length )
                  fill++;
      }
      /**
        * Removes the top entry from the stack
        */
      public void remove( )
      {
            if( fill > 0 )
            {
                  fill--;
                  idx--;
            }
      }
      /**
        * Returns the top entry from the stack
        */
      public Anchor get( )
      {
            return ( fill > 0) ? anchors[idx % anchors.length] : null;
      }
}
class Shell
{
      public final List<Coordinate>shell;
      public List<List<Coordinate>> holes;
      public Shell( List<Coordinate> shell )
      {
            this.shell= shell;
      }
      public void addHole( List<Coordinate> hole )
      {
            if( holes == null )
                  holes= new ArrayList<List<Coordinate>>( 3 );
            holes.add( hole );
      }
      public LinearRing getShellAsLinearRing( )
      {
            try
            {
                  return toLinearRing( shell );
            }
            catch( Exception e )
            {
                  e.printStack Trace( );
                  return null;
            }
      }
      public LinearRing[ ] getHolesAsLinearRings( boolean lazyMode )
      {
            if( holes == null )
                  return null;
            List<LinearRing> rings= new ArrayList<LinearRing>( holes.size( ) );
            for( int i= 0; i < holes.size( ); i++ )
            {
                  LinearRing lr= toLinearRing( holes.get( i ) );
                  if( lazyMode ∥ lr. isValid( ) )
                        rings.add( lr );
            }
            return ( rings.size( ) == 0 ) ? null : rings.toArray( new LinearRing[rings.size( )]
);
      }
      public static LinearRing toLinearRing( List<Coordinate> polyline )
      {
            Coordinate[ ] coords= polyline.toArray( new Coordinate[polyline.size( )] );
            CoordinateSequence coordSeq=
OsmPostalProcessor.geometryFactory.getCoordinateSequenceFactory( ).create( coords );
            return new LinearRing( coordSeq, OsmPostalProcessor.geometryFactory );
      }
}
```

In another embodiment, the system 100 can use the synthetic/approximated postal code area(s) for grouping of routing targets, limiting search scopes for applications such as last-mile routing, fleet route planning, shared vehicle routing, etc. For instance, where a particular location's postal code is unknown, the system 100 can determine whether an address of the particular location is contained in a given postal code area. If it is, the address can be considered, for example, for delivery by the same vehicle/driver, forming a part of the same route, etc.

Therefore, the system 100 can generate area borders for any set of spatially distributed points with identifiable characteristic(s) that cluster in certain areas. Other examples than postal code areas include a height-profile (e.g., from geographic coordinates), crime areas (e.g., low vs. high crime areas), air-pollution/noise areas (e.g., data from measuring stations), LiDAR point clustering, forests/city/street/building areas out of aerial images (e.g., using pixel colors as area codes with regular point sampling over the images), etc. The system 100 can then use synthetic/approximated area(s) for map-making and thus routing and map-display.

In one embodiment, the system 100 can use machine learning solutions to automatically determine the intermediate point location on the determined triangle edge, considering the nature and characteristics of the code and/or desired border results (e.g., smoother borders).

In one embodiment, the system 100 can collect the spatially distributed points by processing probe data and/or sensor data from one or more vehicles 103a-103n (also collectively referred to as vehicles 103) (e.g., standard vehicles, autonomous vehicles, heavily assisted driving (HAD) vehicles, semi-autonomous vehicles, etc.). In one instance, the vehicles 103 include one or more vehicle sensors 105a-105n (also collectively referred to as vehicle sensors 105) and have connectivity to a mapping platform 107 via a communication network 109. By way of example, a vehicle sensor 105 may include a RADAR system, a LiDAR system, a global positioning sensor for gathering probe data (e.g., GPS probe data). In one embodiment, the probe data may be reported as probe points, which are individual data records collected at a point in time that records telemetry data for that point in time. A geospatial point can include attributes such as: (1) point ID, (2) longitude, (3) latitude, (4) altitude, (5) code ID, (6) time, and optionally (7) heading and (8) speed.

In another embodiment, the system 100 can also collect spatially distributed points from one or more user equipment (UE) 111a-111n (also collectively referenced to herein as UEs 111) associated with the vehicles 103 (e.g., an embedded navigation system), users or passengers of the vehicles 103 (e.g., a mobile device, a smartphone, a client terminal, etc.), or a combination thereof. In one instance, the UEs 111 may include one or more applications 113a-113n (also collectively referred to herein as applications 113) (e.g., a navigation or mapping application). In one embodiment, the system 100 may also collect spatially distributed points from one or more other sources such as government/municipality agencies, local or community agencies (e.g., police departments), and/or third-party official/semi-official sources (e.g., a services platform 115, one or more services 117a-117n, one or more content providers 119a-119m, etc.). In one instance, the spatially distributed points collected by the vehicle sensors 105, the UEs 111, one or more other sources, or a combination thereof may be stored in a geospatial point layer 121 of a geographic database 123 or a combination thereof.

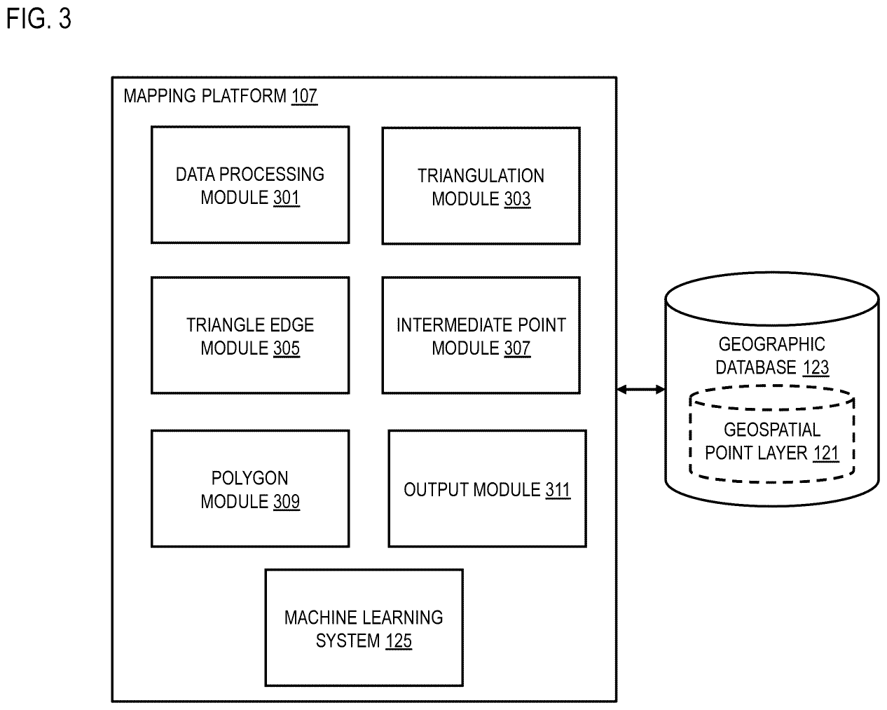

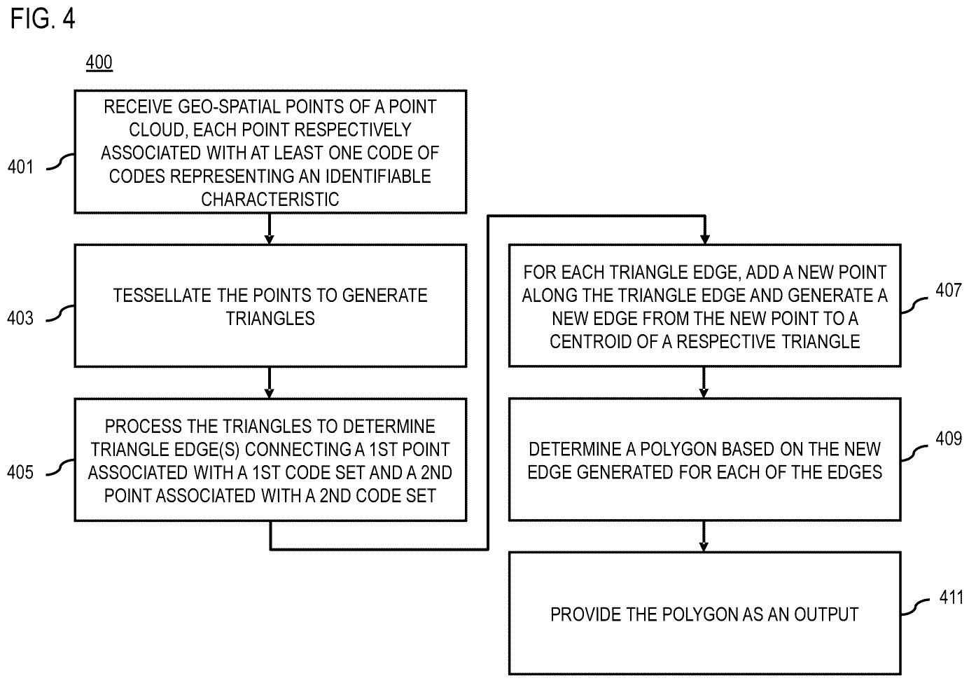

FIG. 3 is a diagram of the components of the mapping platform 107, according to example embodiment(s). By way of example, the mapping platform 107 includes one or more components for approximating border(s) between clusters of geospatial points based on triangulation, according to the various embodiments described herein. It is contemplated that the functions of these components may be combined or performed by other components of equivalent functionality. In one embodiment, the mapping platform 107 includes a data processing module 301, a triangulation module 303, a triangle edge module 305, an intermediate point module 307, a polygon module 309, an output module 311, and a machine learning system 125, and has connectivity to the geographic database 123 including the geospatial point layer 121. The above presented modules and components of the mapping platform 107 can be implemented in hardware, firmware, software, or a combination thereof. Though depicted as a separate entity in FIG. 1, it is contemplated that the mapping platform 107 may be implemented as a module of any other component of the system 100. In another embodiment, the mapping platform 107 and/or the modules 301-311 may be implemented as a cloud-based service, local service, native application, or combination thereof. The functions of the mapping platform 107, the machine learning system 125, and/or the modules 301-311 are discussed with respect to FIG. 4-6.

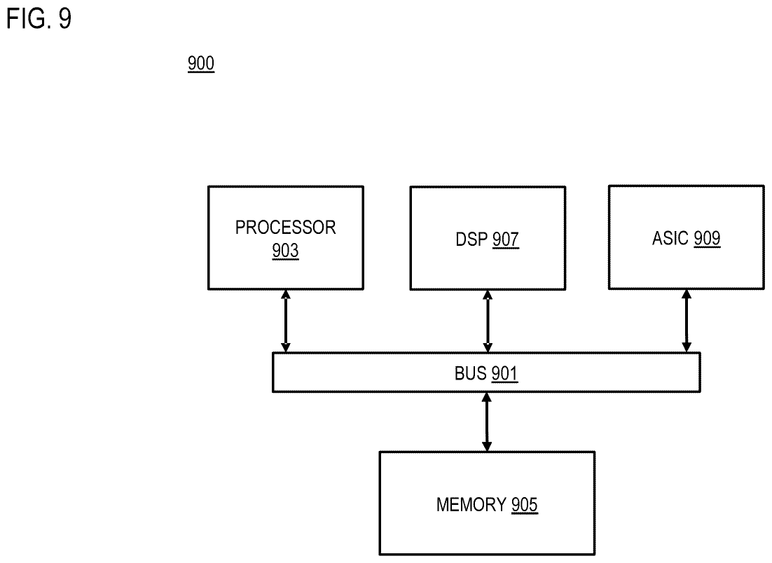

FIG. 4 is a flowchart of a process for approximating border(s) between clusters of geospatial points based on triangulation, according to example embodiment(s). In various embodiments, the mapping platform 107, the machine learning system 125, and/or any of the modules 301-311 may perform one or more portions of the process 400 and may be implemented in, for instance, a chip set including a processor and a memory as shown in FIG. 9. As such, the mapping platform 107, the machine learning system 125, and/or the modules 301-311 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

In one embodiment, for example, in step 401, the data processing module 301 can receive a plurality of points of a point cloud, and the points can be geospatial points and are respectively associated with at least one code of a plurality of codes representing an identifiable characteristic. By way of example, the plurality of codes includes a postal code (e.g., FIGS. 2B-2E), a height-profile code, a crime rate code, an air-pollution code, a noise code, a school district code, a flood zone code, a zoning code, an aerial image code, a taxi rate zone code, a subway rate zone code, a franchise territory code (e.g., FIG. 2A), or an electoral district code.

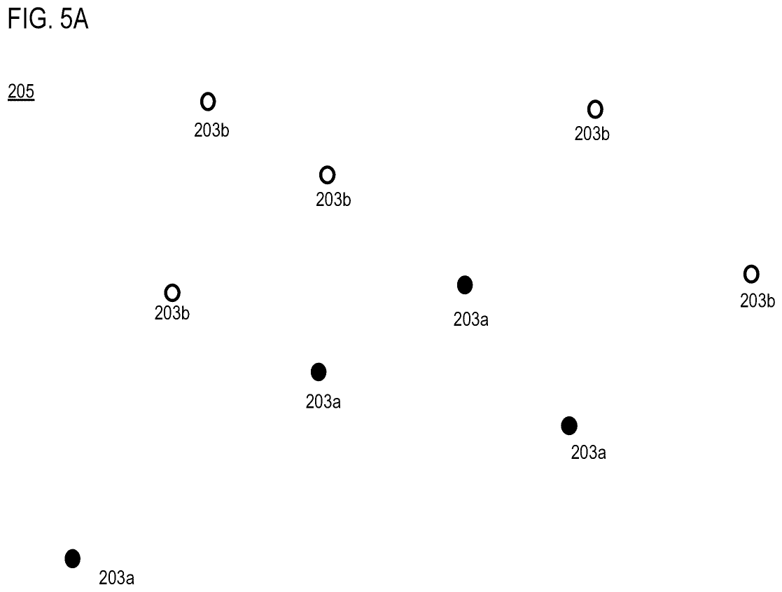

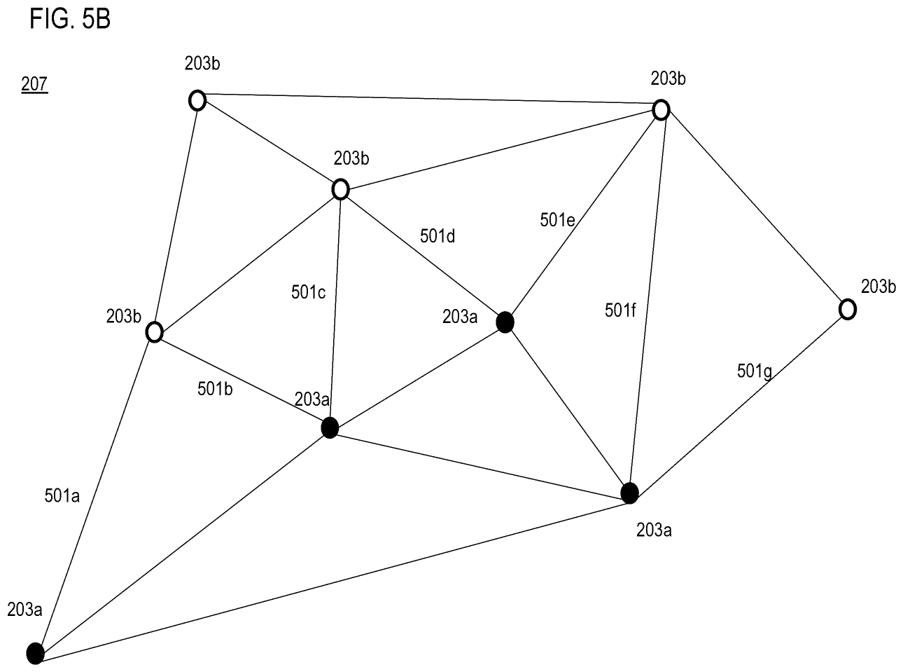

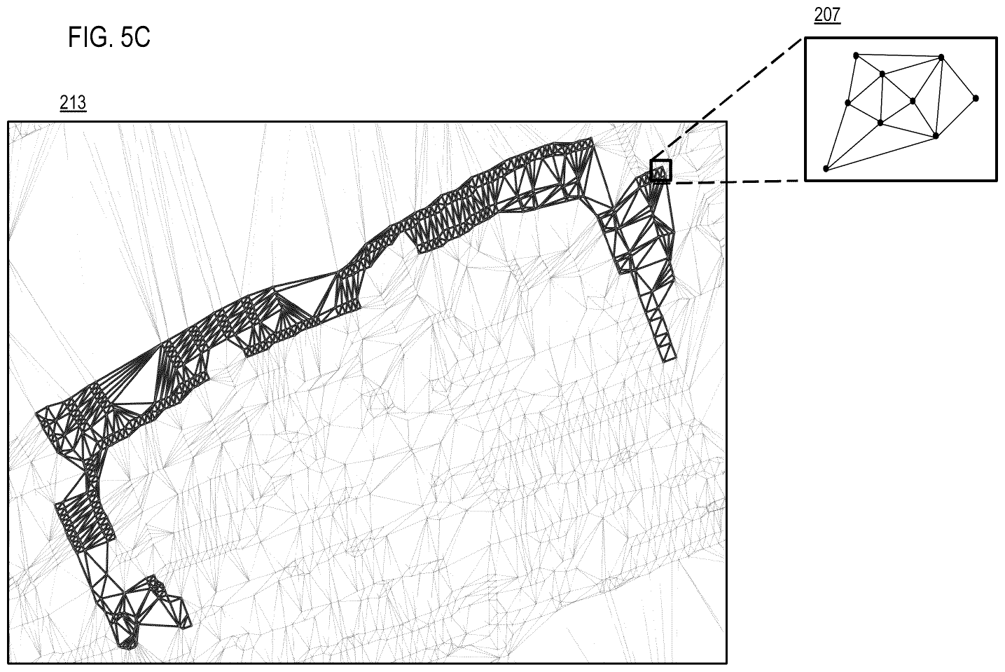

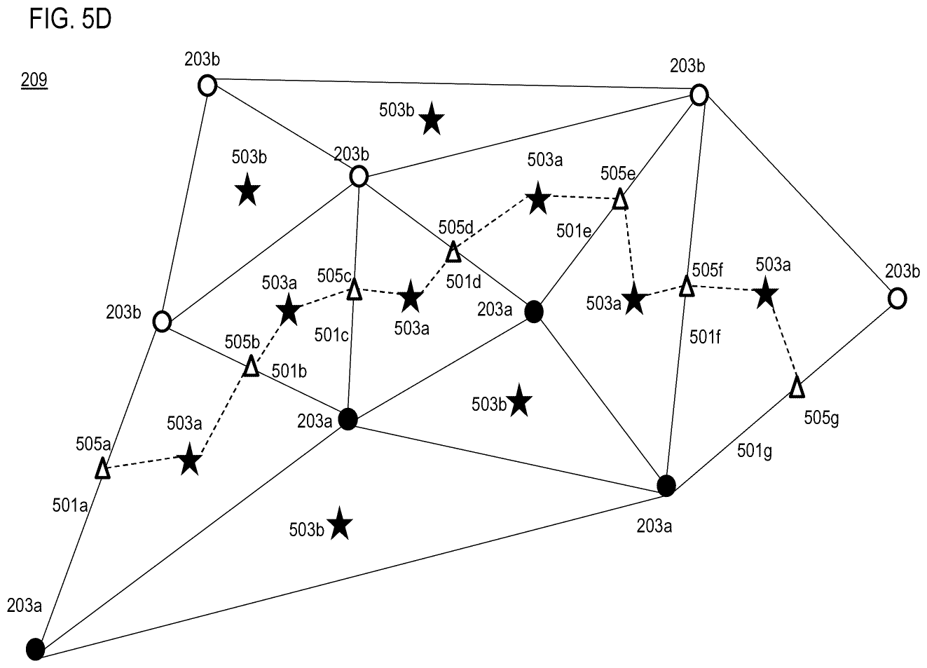

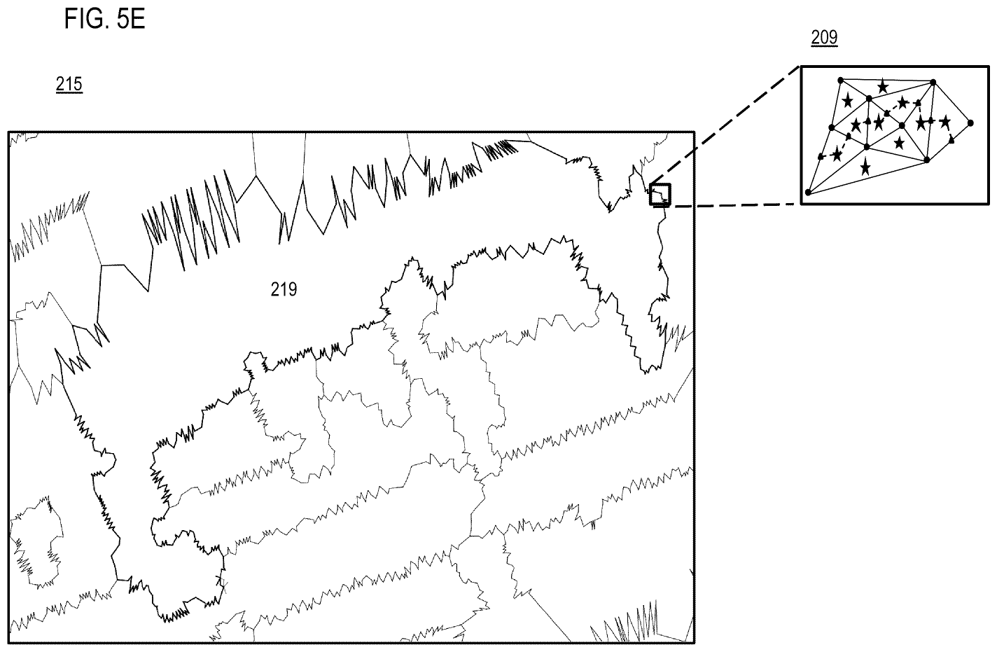

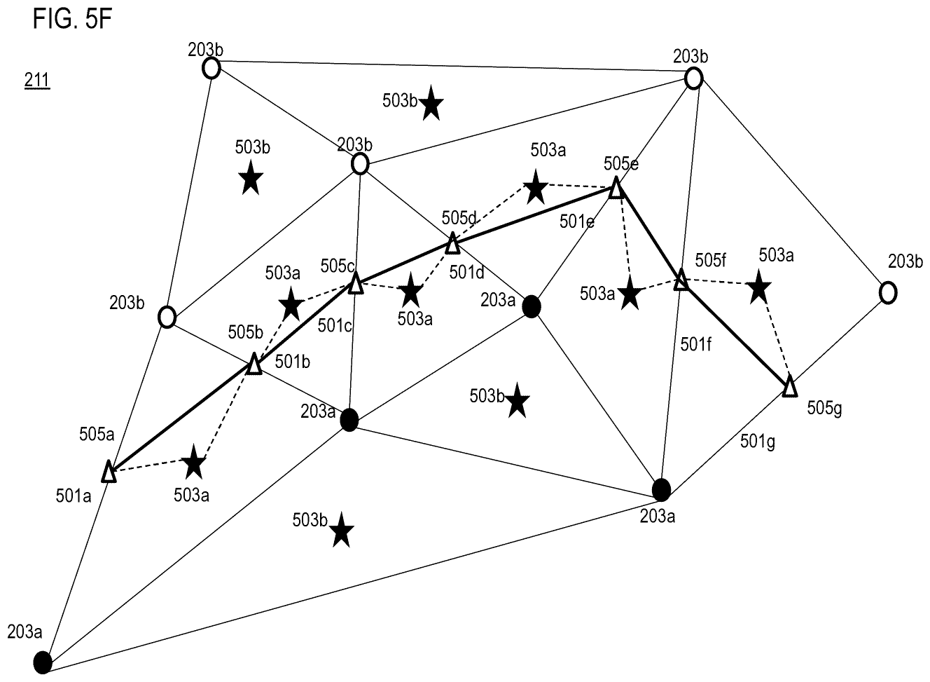

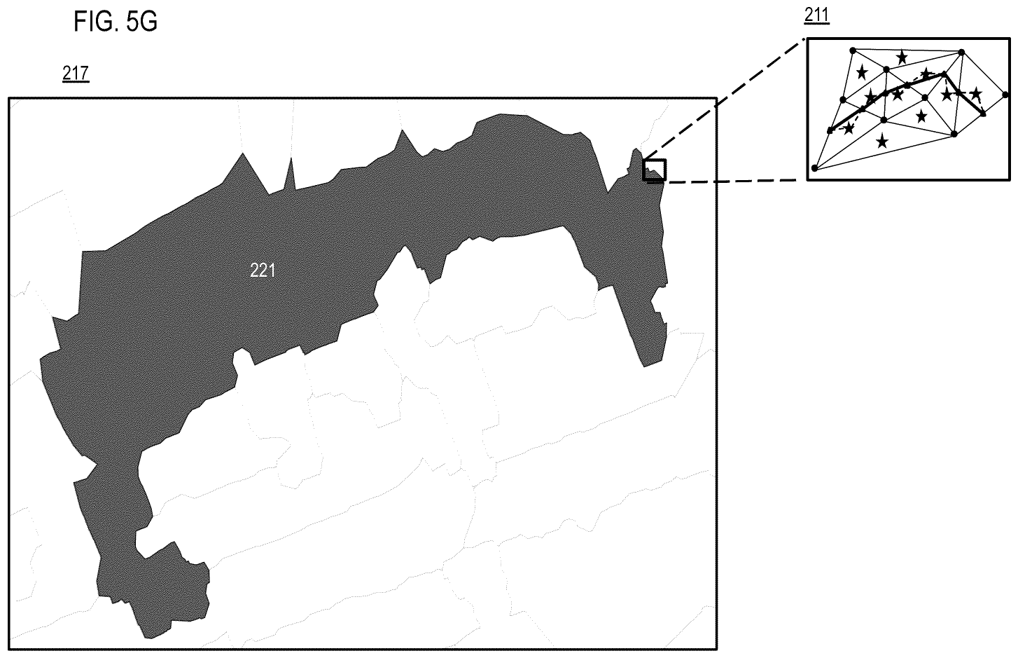

Referring back to the postal code example of FIGS. 2B-2E, FIGS. 5A-5G are detailed diagrams for approximating border(s) between areas/clusters of postal code geospatial data points of FIGS. 2B-2E, according to example embodiment(s). FIG. 5A is an enlarged view of the diagram 205 that shows a small set of the geospatial data points 203 including darkened geospatial data points 203a of a first postal code (e.g., postal code 2539 in Luxembourg) and the remaining geospatial data points 203b of other postal code(s) (e.g., postal codes 1267, 1268, 1853, 1862, 2131, 2137, 2222, 2511, 2623, 2624, 2630, 2738 in Luxembourg).

In one embodiment, in step 403, the triangulation module 303 can tessellate the plurality of points to generate a plurality of triangles. For instance, FIG. 5B is an enlarged view of the diagram 207 that shows the geospatial data points 203a, 203b in the diagram 205 tessellated into triangles irrespective of their postal codes. Each triangle has three edges defined by three points.

In one embodiment, in step 405, the triangle edge module 305 can process the plurality of triangles to determine one or more triangle edges that connect a first point (e.g., darkened geospatial data points 203a) associated with a first set of one or more codes (e.g., postal code 2539 in Luxembourg) of the plurality of codes and a second point (e.g., geospatial data points 203b) associated with a second set of one or more codes (e.g., postal code 1267 in Luxembourg) of the plurality of codes, and the first set is different from the second set. The first code set and the second code set can share none, some, or all codes. By way of example, the first code set can be {“CODE-A,” “CODE-B,” “CODE-C”}, and the second code set can be {“CODE-A,” “CODE-C,” “CODE-D,” “CODE-F”}. In other words, codes of the points of an edge can be associated with the same code or share none, some, or all codes they are associated with. For instance, triangle edges 501a-501g in FIG. 5B connecting between a postal code 2539 point and a postal code 1267.

FIG. 5C depicts the zoom-in diagram 207 of FIG. 5B with respect to a top-right corner area of the overhead view diagram 213. As mentioned, the diagram 213 includes darkened triangles made from darkened geospatial data points 203a of the first postal code (e.g., postal code 2539 in Luxembourg) and other triangles are made from the remaining geospatial data points 203b of other postal code(s) (e.g., postal codes 1267, 1268, 1853, 1862, 2131, 2137, 2222, 2511, 2623, 2624, 2630, 2738 in Luxembourg).

In one embodiment, in step 407, for each of the one or more determined triangle edges (e.g., the triangle edges 501a-501g in FIG. 5B), the intermediate point module 307 can add a new point along the one or more determined triangle edge (e.g., an intermediate point of each determined triangle edge). For instance, FIG. 5D is an enlarged view of the diagram 209 that depicts triangle centroids 503 (e.g., shown as a star icon) and intermediate points 505 (e.g., shown as an equilateral triangle icon) of a respective determined triangle edge 501. The triangle centroids 503 in FIG. 5D include one set of triangle centroids 503a that are associated with the triangle edges 501a-501g connecting between a postal code 2539 point and a postal code 1267, and the other set of triangle centroids 503b that are not associated with the triangle edges 501a-501g.

In one embodiment, the triangle edge module 305 can generate a new edge (e.g., the triangle edge in a dot line in FIG. 5D) from the new point (e.g., each of the intermediate points 505a-505g of their respective determined triangle edges 501a-501g) to a centroid (e.g., a triangle centroids 503a) of a respective triangle. For instance, the new point can be determined as a halfway point between the first point and the second point. Either a heuristic solution or a machine learning solution can be applied to decide the position of an intermediate point of a triangle edge. The heuristic solution can be a simple probabilistic function based on the data to identify the likelihood that the position of an intermediate point of a triangle edge can smoothen the border.

For instance, a position of the new point between the first point and the second point can be determined based on the identifiable characteristic associated with the first point, the second point, or a combination thereof. By way of example, the intermediate point module 307 can process the identifiable characteristic associated with the first point, the identifiable characteristic associated with the second point, another characteristic of the first point or the second point, the one or more determined triangle edges, or a combination thereof using a machine learning model to determine the position of the new point between the first point and the second point, as discussed.

In one embodiment, the machine learning system 125 can determine an intermediate point on a triangle edge based on the nature and characteristics of the code and/or desired border results (e.g., smoother borders). For instance, the machine learning system 125 can train or condition a machine learning model (e.g., a support vector machine (SVM), neural network, decision tree, etc.) using a set of code nature and characteristics related features or inputs (e.g., associated with school redistricting rules stored in and/or accessible via the geospatial point layer 121 and/or the geographic database 123). By way of example, the rules/features in designing school boundaries such that students are assigned to proximal schools while ensuring effective utilization of school capacities may include, but are not limited to, (1) the presence of multiple design criteria such as capacity utilization, proximity and travel time, etc. (2) the fixed locations of schools with widely different capacities to be balanced, (3) the spatial nature of the data and the need to preserve contiguity in school zones, and (4) quantifying local factors, etc. The machine learning model can operate on polygonal geometries and connects them into geographically contiguous school boundaries while balancing problem-specific constraints.

In another embodiment, the machine learning system 125 calculates one or more weighted or not-weighted rules/features for training and use with the machine learning model. In one instance, the machine learning system 125 can train the machine learning model to determine the position of the immediate point thereby approximating border(s) between clusters of geospatial points by assigning weights, correlations, relationships, etc. among the rules/features corresponding to actual and expected area borders. In one embodiment, the machine learning system 125 can continuously provide and/or update the machine learning model during training using, for instance, supervised deep convolution networks or equivalents. In other words, the machine learning system 125 trains the machine learning model using various intermediate point and/or school redistricting features to enable the machine learning system 125 to determine the position of the intermediate point thereby approximating border(s) between clusters of geospatial points.

It is contemplated that by processing different intermediate point position of tringle edges and manipulations of the various thresholds and probability criterion, the system 100 and/or the machine learning system 125 can derive better metrics for determining the position of the intermediate point and automatically identifying/verifying approximated border(s) between clusters of geospatial points and/or scoring such identification/verifications against some sort of ground truth (e.g., a human verified closure).

In one embodiment, in step 409, the polygon module 309 can determine a polygon (e.g., the polygon 219 in FIG. 5E) based on the new edge generated for each of the one or more determined edges, and the polygon can represent a border between the plurality of points associated with the first set and the plurality of points associated with the second set. FIG. 5E depicts the zoom-in diagram 209 of FIG. 5D with respect to a top-right corner area of the overhead view diagram 215. As mentioned, the diagram 215 shows the darkened rough border 219 connected from darkened new edges of the first postal code (e.g., postal code 2539 in Luxembourg) and other rough borders connected from other new edges of the other postal code(s) (e.g., postal codes 1267, 1268, 1853, 1862, 2131, 2137, 2222, 2511, 2623, 2624, 2630, 2738 in Luxembourg).

In another embodiment, the polygon module 309 can remove the centroid of the respective triangle from the polygon, for example, thereby smoothing the border (e.g., into the synthetic/approximated postal code area 221 in FIG. 5G). For instance, FIG. 5F is an enlarged view of the diagram 211 that depicts a smoothened border (e.g., shown as a thickened black line) that directly connects the triangle edges 501a-501g (without going via the triangle centroids 503a).

FIG. 5G depicts the zoom-in diagram 211 of FIG. 5F with respect to a top-right corner area of the overhead view diagram 217. As mentioned, the diagram 217 highlights the synthetic/approximated postal code area 221 of the first postal code (e.g., postal code 2539 in Luxembourg) and other smoothened borders of the other postal code(s) (e.g., postal codes 1267, 1268, 1853, 1862, 2131, 2137, 2222, 2511, 2623, 2624, 2630, 2738 in Luxembourg).

In yet another embodiment, the polygon module 309 can determine that the polygon (e.g., the polygon 225 in FIG. 2E) is enclosed within another polygon (e.g., the polygon 223 in FIG. 2E) as a hole of the other polygon, provide a multi-polygon including the other polygon as a primary polygon and excluding the hole as a secondary polygon, and include the multi-polygon in the output.

In one embodiment, in step 411, the output module 311 can provide the polygon as an output. For instance, the output module 311 can process the output to generate digital map data to represent the border in a geographic database. As another instance, the output module 311 can generate a mapping user interface, a navigation user interface, or a combination thereof based on the output. As yet another instance, the output module 311 can limit query results to a spatial search based on the output. For instance, the spatial search can be based on a navigation routing request, and the output module 311 can generate a navigation route based on the polygon, and provide the navigation route for one or more vehicles. For instance, the one or more vehicles can include one or more delivery vehicles, one or more ride-sharing vehicles, or a combination thereof.

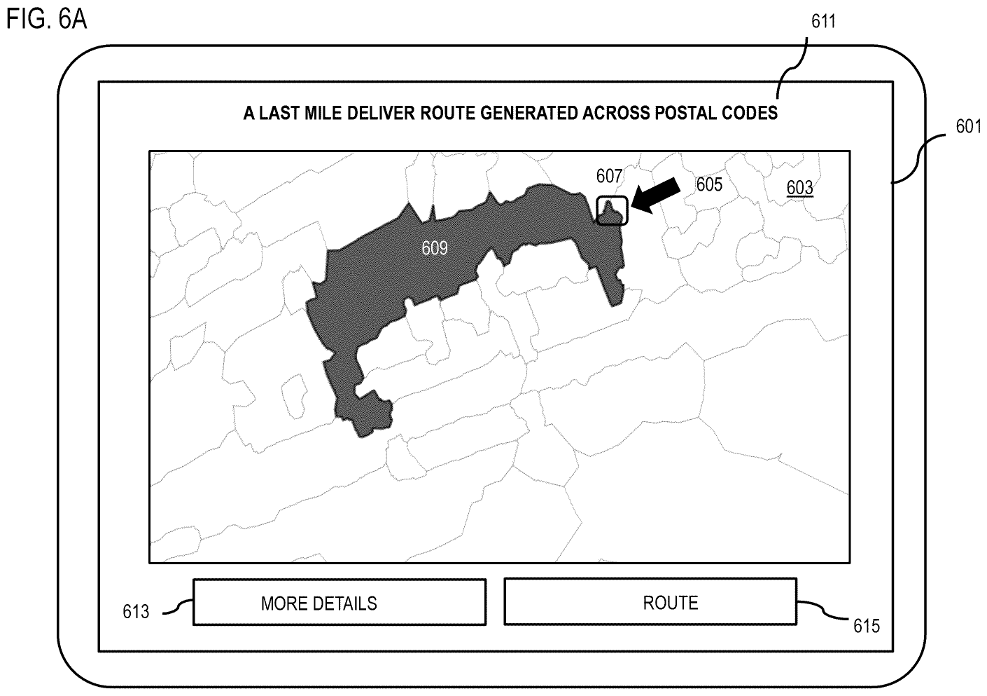

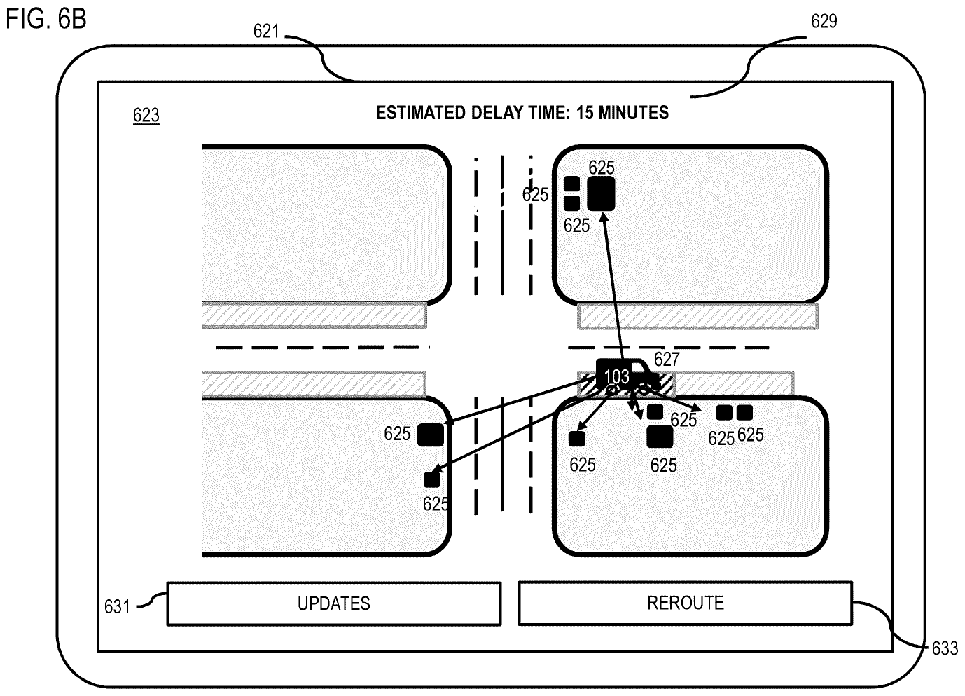

FIGS. 6A and 6B are diagrams of example navigation user interfaces associated with an approximated border between postal codes, according to example embodiment(s). Last mile delivery of goods to customers (e.g., delivery of goods from a nearest delivery transportation hub to the final destinations) dynamically conditioned upon geospatial clustering the delivery destinations into one or more last mile delivery routes considering, e.g., available parking at the delivery location, delivery time windows, traffic, weather, etc. and can affect where, when, and how deliveries can be made. A user interface (UI) 601 in FIG. 6A (e.g., a navigation application 113a) is generated for a UE 111 (e.g., a mobile device, an embedded navigation system, a client terminal, etc.). The UI 601 shows a map 603, an arrow 605 pointing towards a delivery order cluster 607 within an approximated postal code border 609 generated based on the above-discussed embodiments, and a message 611: “A last mile delivery route generated across postal codes.” The UI 601 also shows a “More Details” button 613 and a “Route” button 615. For examples, a user can interact with the UI 601 via one or more physical interactions (e.g., a touch, a tap, a gesture, typing, etc.), one or more voice commands (e.g., “verify road closure,” “flag road closure,” etc.), or a combination thereof. When the user selects the “Route” button 615,

When the user selects the “More Details” button 613, a UI 621 in FIG. 6B shows a zoom-in map 623 of the delivery order cluster 607 of delivery orders 625 for a delivery vehicle 103 parking at a location 627, and a message 629: “Estimated Delay Time: 15 minutes.” When the user selects the “Route” button 615, the system 100 can generate routing directions for the delivery order cluster 607.

The UI 621 also shows an “Updates” button 631 and a “Reroute” button 633. When the user selects the “Updates” button 631, the system 100 can display updates including delivery address change(s), path closure(s), building cashier unavailable, etc. When the user selects the “Reroute” button 633, the system 100 can generate new routing directions for the delivery order cluster 607 based on the updates. It is contemplated that in this instance, the system 100 can determine or detect one or more actions by a user (e.g., an eye gaze) and automatically confirm the acceptance of routing directions.

The above-discussed embodiments provide simple (e.g., not requiring long-term historical context) and effective (e.g., computational inexpensive, less susceptible to location sensor data statistical variability and/or errors) ways to approximate code area borders methodically, drastically reducing sourcing issues. In addition, machine learning and/or heuristic/probabilistic algorithms can be added to identify indeterminate points for generating the borders. Information of the code area borders can be used to improve mapping and navigation (e.g., delivery vehicles, shared vehicles, etc.), traffic, road design, etc.

Returning to FIG. 1, in one embodiment, the mapping platform 107 performs the process for approximating border(s) between clusters of geospatial points based on triangulation as discussed with respect to the various embodiments described herein. For example, the mapping platform 107 can generate intermediate point on triangle edge related features for machine learning solutions.

In one embodiment, the mapping platform 107 has connectivity over the communications network 109 to the services platform 115 (e.g., a fleet management platform) that provides the services 117a-117n (also collectively referred to herein as services 117) (e.g., geospatial data and/or sensor data collection services). By way of example, the services 117 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 115 uses the output (e.g. area borders) of the mapping platform 107 to provide services such as navigation, mapping, other location-based services, etc.

In one embodiment, the mapping platform 107 may be a platform with multiple interconnected components. The mapping platform 107 may include multiple servers, intelligent networking devices, computing devices, components, and corresponding software for providing parametric representations of lane lines. In addition, it is noted that the mapping platform 107 may be a separate entity of the system 100, a part of the services platform 115, a part of the one or more services 117, or included within a vehicle 103 (e.g., an embedded navigation system).

In one embodiment, content providers 119 may provide content or data (e.g., including geospatial data, expected vehicle volume data, road closure reports, etc.) to the mapping platform 107, the UEs 111, the applications 113, the services platform 115, the services 117, the geospatial point layer 121, the geographic database 123, and the vehicles 103. The content provided may be any type of content, such as map content, textual content, audio content, video content, image content, etc. In one embodiment, the content providers 119 may provide content regarding the expected frequency of vehicles 103 on the digital map or link as well as content that may aid in localizing a vehicle path or trajectory on a digital map or link (e.g., to assist with determining actual vehicle volumes on a road network). In one embodiment, the content providers 119 may also store content associated with the mapping platform 107, the services platform 115, the services 117, the geospatial point layer 121, the geographic database 123, and/or the vehicles 103. In another embodiment, the content providers 119 may manage access to a central repository of data, and offer a consistent, standard interface to data, such as a repository of the geospatial point layer 121 and/or the geographic database 123.

By way of example, the UEs 111 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 111 can support any type of interface to the user (such as “wearable” circuitry, etc.). In one embodiment, a UE 111 may be associated with a vehicle 103 (e.g., a mobile device) or be a component part of the vehicle 103 (e.g., an embedded navigation system). In one embodiment, the UEs 111 may include the mapping platform 107 to approximate border(s) between clusters of geospatial points based on triangulation.

In one embodiment, as mentioned above, the vehicles 103, for instance, are part of a geospatial-point-based system for collecting geospatial data for approximating border(s) between clusters of geospatial points based on triangulation (e.g., postal code areas). In one embodiment, each vehicle 103 is configured to report geospatial data as geospatial points, which are individual data records collected at a point in time that records telemetry data for that point in time. In one embodiment, the point ID can be permanent or valid for a certain period of time. In one embodiment, the point ID is cycled, particularly for consumer-sourced data, to protect the privacy of the source.

In one embodiment, a geospatial point can include attributes such as: (1) point ID, (2) longitude, (3) latitude, (4) altitude, (5) code ID, (6) time, and optionally (7) heading and (8) speed. The list of attributes is provided by way of illustration and not limitation. Accordingly, it is contemplated that any combination of these attributes or other attributes may be recorded as a geospatial point. For example, attributes such as altitude (e.g., for flight capable vehicles or for tracking non-flight vehicles in the altitude domain), tilt, steering angle, wiper activation, etc. can be included and reported for a geospatial point. In one embodiment, the vehicles 103 may include vehicle sensors 105 for reporting measuring and/or reporting attributes. The attributes can also be any attribute normally collected by an on-board diagnostic (OBD) system of the vehicle 103, and available through an interface to the OBD system (e.g., OBD II interface or other similar interface).

The geospatial points can be reported from the vehicles 103 in real-time, in batches, continuously, or at any other frequency requested by the system 100 over, for instance, the communication network 109 for processing by the mapping platform 107. The geospatial points also can be map matched to specific map features stored in the geographic database 123. In one embodiment, the system 100 (e.g., via the mapping platform 107) generates vehicle paths or trajectories from the observed and expected frequency of geospatial points for an individual code as discussed with respect to the various embodiments described herein so that the geospatial point traces represent a travel trajectory or vehicle path through the geographic area.

In one embodiment, as previously stated, the vehicles 103 are configured with various sensors (e.g., vehicle sensors 105) for generating or collecting geospatial point data, probe data, sensor data, related geographic/map data, etc. In one embodiment, the sensed data represents sensor data associated with a geographic location or coordinates at which the sensor data was collected (e.g., a latitude and longitude pair). In one embodiment, the probe data (e.g., stored in the geospatial point layer 121) includes location probes collected by one or more vehicle sensors 105. By way of example, the vehicle sensors 105 may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 103, switch sensors for determining whether one or more vehicle switches are engaged, and the like. Though depicted as automobiles, it is contemplated the vehicles 103 can be any type of vehicle manned or unmanned (e.g., cars, trucks, buses, vans, motorcycles, scooters, drones, etc.) that travels through road segments of a road network.

Other examples of sensors 105 of a vehicle 103 may include light sensors, orientation sensors augmented with height sensors and acceleration sensor (e.g., an accelerometer can measure acceleration and can be used to determine orientation of the vehicle), tilt sensors to detect the degree of incline or decline of a vehicle 103 along a path of travel, moisture sensors, pressure sensors, etc. In a further example embodiment, vehicle sensors 105 about the perimeter of a vehicle 103 may detect the relative distance of the vehicle 103 from a physical divider, a lane line of a link or roadway, the presence of other vehicles, pedestrians, traffic lights, potholes and any other objects, or a combination thereof. In one scenario, the vehicle sensors 105 may detect weather data, traffic information, or a combination thereof. In one embodiment, a vehicle 103 may include GPS or other satellite-based receivers 105 to obtain geographic coordinates from satellites 127 for determining current location and time. Further, the location can be determined by visual odometry, triangulation systems such as A-GPS, Cell of Origin, or other location extrapolation technologies.

In one embodiment, the UEs 111 may also be configured with various sensors (not shown for illustrative convenience) for acquiring and/or generating geospatial point data and/or sensor data associated with a vehicle 103, a driver, a passenger, other vehicles, conditions regarding the driving environment or roadway, etc. For example, such sensors may be used as GPS receivers for interacting with the one or more satellites 127 to determine and track the current speed, position and location of a vehicle 103 travelling along a link or road segment. In addition, the sensors may gather tilt data (e.g., a degree of incline or decline of the vehicle during travel), motion data, light data, sound data, image data, weather data, temporal data and other data associated with the vehicles 103 and/or UEs 111. Still further, the sensors may detect local or transient network and/or wireless signals, such as those transmitted by nearby devices during navigation of a vehicle along a roadway (Li-Fi, near field communication (NFC)) etc.

It is noted therefore that the above described data may be transmitted via the communication network 109 as probe data (e.g., GPS probe data) according to any known wireless communication protocols. For example, each UE 111, application 113, user, and/or vehicle 103 may be assigned a unique geospatial point identifier (point ID) for use in reporting or transmitting said geospatial point data collected by the vehicles 103 and/or UEs 111. In one embodiment, each vehicle 103 and/or UE 111 is configured to report geospatial point data, which are individual data records collected at a point in time that records telemetry data.

In one embodiment, the mapping platform 107 retrieves aggregated geospatial points gathered and/or generated by the vehicle sensors 105 and/or the UEs 111 resulting from the travel of the UEs 111 and/or vehicles 103 in a geographic area. In one instance, the geospatial point layer 121 stores a plurality of geospatial point points and/or trajectories generated by different vehicle sensors 105, UEs 111, applications 113, vehicles 103, etc. over a period while traveling in a large, monitored area. A time sequence of geospatial points specifies a trajectory—i.e., a path traversed by a UE 111, application 113, vehicle 103, etc. over the period. In one instance, as the time between geospatial points increases, so does the distance and the possible code areas defined by the geospatial points.

In one embodiment, the communication network 109 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the vehicles 103, vehicle sensors 105, mapping platform 107, UEs 111, applications 113, services platform 115, services 117, content providers 119, and/or satellites 127 communicate with each other and other components of the system 100 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

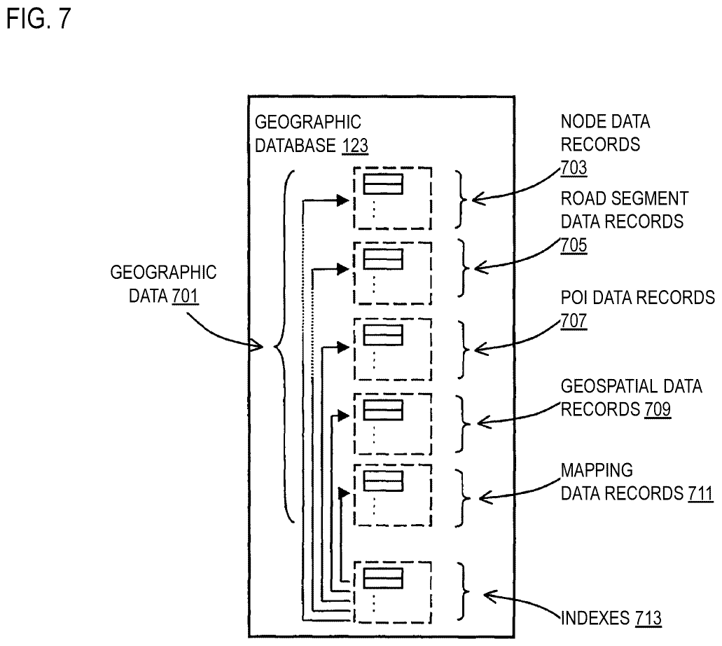

FIG. 7 is a diagram of a geographic database (such as the database 123), according to one embodiment. In one embodiment, the geographic database 123 includes geographic data 701 used for (or configured to be compiled to be used for) mapping and/or navigation-related services, such as for video odometry based on the parametric representation of lanes include, e.g., encoding and/or decoding parametric representations into lane lines. In one embodiment, the geographic database 123 include high resolution or high definition (HD) mapping data that provide centimeter-level or better accuracy of map features. For example, the geographic database 123 can be based on Light Detection and Ranging (LiDAR) or equivalent technology to collect very large numbers of 3D points depending on the context (e.g., a single street/scene, a country, etc.) and model road surfaces and other map features down to the number lanes and their widths. In one embodiment, the mapping data (e.g., mapping data records 711) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. As another example, continuous features that can be described by a polygon, such as the discussed embodiments for approximating border(s) between different areas/clusters of geospatial data points, can be assigned with a code ID. The point locations associated with the code ID would be located inside the polygon. When adding new point locations, the polygon can be recomputed and redefined by simply assigning the code ID to the new point locations and applying the described method. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 123.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 123 follows certain conventions. For example, links do not cross themselves and do not cross each other except at a node. Also, there are no duplicated shape points, nodes, or links. Two links that connect each other have a common node. In the geographic database 123, overlapping geographic features are represented by overlapping polygons. When polygons overlap, the boundary of one polygon crosses the boundary of the other polygon. In the geographic database 123, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 123 includes node data records 703, road segment or link data records 705, POI data records 707, geospatial data records 709, mapping data records 711, and indexes 713, for example. More, fewer or different data records can be provided. In one embodiment, additional data records (not shown) can include cartographic (“cartel”) data records, routing data, and maneuver data. In one embodiment, the indexes 713 may improve the speed of data retrieval operations in the geographic database 123. In one embodiment, the indexes 713 may be used to quickly locate data without having to search every row in the geographic database 123 every time it is accessed. For example, in one embodiment, the indexes 713 can be a spatial index of the polygon points associated with stored feature polygons.

In exemplary embodiments, the road segment data records 705 are links or segments representing roads, streets, or paths, as can be used in the calculated route or recorded route information for determination of one or more personalized routes. The node data records 703 are end points (such as intersections) corresponding to the respective links or segments of the road segment data records 705. The road link data records 705 and the node data records 703 represent a road network, such as used by vehicles, cars, and/or other entities. Alternatively, the geographic database 123 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 123 can include data about the POIs and their respective locations in the POI data records 707 (e.g., that have a (postal) code ID associated with as discussed). The geographic database 123 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city). In one embodiment, certain attributes, such as lane marking data records, mapping data records and/or other attributes can be features or layers associated with the link-node structure of the database.

In one embodiment, the geographic database 123 can also include geospatial data records 709 for storing geospatial point data, geospatial point cloud(s), code definition and characteristic data, machine learning model data, training data, prediction models, annotated observations, computed featured distributions, sampling probabilities, and/or any other data generated or used by the system 100 according to the various embodiments described herein. By way of example, the geospatial data records 709 can be associated with one or more of the node records 703, road segment records 705, and/or POI data records 707 to support localization or visual odometry based on the features stored therein and the corresponding estimated quality of the features. In this way, the records 709 can also be associated with or used to classify the characteristics or metadata of the corresponding records 703, 705, and/or 707.

In one embodiment, as discussed above, the mapping data records 711 model road surfaces and other map features to centimeter-level or better accuracy. The mapping data records 711 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 711 are divided into spatial partitions of varying sizes to provide mapping data to vehicles 103 and other end user devices with near real-time speed without overloading the available resources of the vehicles 103 and/or devices (e.g., computational, memory, bandwidth, etc. resources).

In one embodiment, the mapping data records 711 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 123 can be maintained by the content provider 119 in association with the services platform 115 (e.g., a map developer). The map developer can collect geographic data to generate and enhance the geographic database 123. There can be different ways used by the map developer to collect data. These ways can include obtaining data from other sources, such as municipalities or respective geographic authorities. In addition, the map developer can employ field personnel to travel by vehicle (e.g., vehicles 103 and/or UEs 111) along roads throughout the geographic region to observe features and/or record information about them, for example. Also, remote sensing, such as aerial or satellite photography, can be used.

The geographic database 123 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 103 or a UE 111, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for approximating border(s) between clusters of geospatial points based on triangulation may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

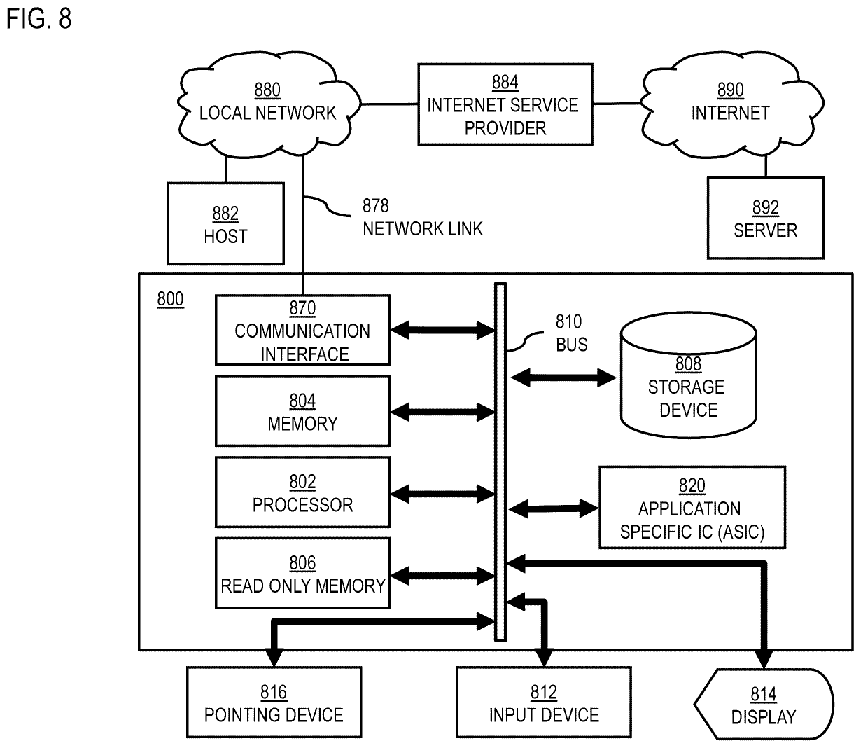

FIG. 8 illustrates a computer system 800 upon which an embodiment of the invention may be implemented. Computer system 800 is programmed (e.g., via computer program code or instructions) to approximate border(s) between clusters of geospatial points based on triangulation as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to approximating border(s) between clusters of geospatial points based on triangulation. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RANI) or other dynamic storage device, stores information including processor instructions for approximating border(s) between clusters of geospatial points based on triangulation. Dynamic memory allows information stored therein to be changed by the computer system 800. RANI allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for approximating border(s) between clusters of geospatial points based on triangulation, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for approximating border(s) between clusters of geospatial points based on triangulation.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which an embodiment of the invention may be implemented. Chip set 900 is programmed to approximate border(s) between clusters of geospatial points based on triangulation as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to approximate border(s) between clusters of geospatial points based on triangulation. The memory 905 also stores the data associated with or generated by the execution of the inventive steps.

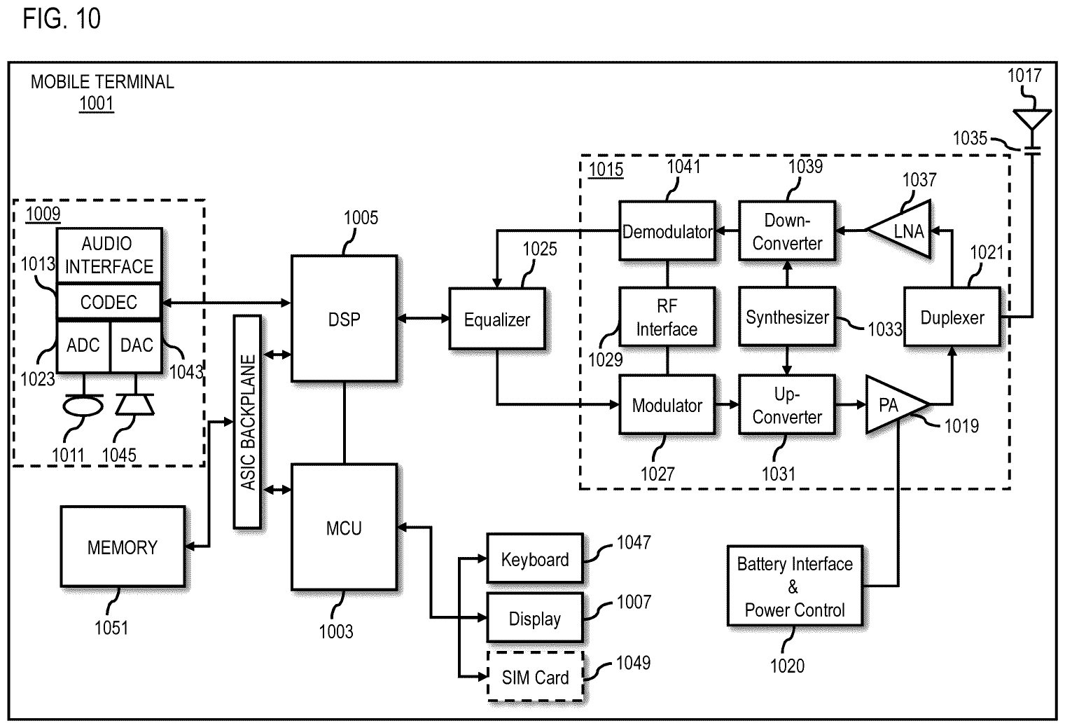

FIG. 10 is a diagram of exemplary components of a mobile terminal 1001 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to approximate border(s) between clusters of geospatial points based on triangulation. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a plurality of points of a point cloud, wherein the points are geospatial points and are respectively associated with at least one code of a plurality of codes representing an identifiable characteristic;
tessellating the plurality of points to generate a plurality of triangles;
processing the plurality of triangles to determine one or more triangle edges that connect a first point associated with a first set of one or more codes of the plurality of codes and a second point associated with a second set of one or more codes of the plurality of codes, wherein the first set is different from the second set;
for each of the one or more determined triangle edges, adding a new point along the one or more determined triangle edge and generating a new edge from the new point to a centroid of a respective triangle;
determining a polygon based on the new edge generated for each of the one or more determined edges, wherein the polygon represents a border between the plurality of points associated with the first set and the plurality of points associated with the second set; and
providing the polygon as an output.

2. The method of claim 1, further comprising:
removing the centroid of the respective triangle from the polygon.

3. The method of claim 1, further comprising:
processing the output to generate digital map data to represent the border in a geographic database.

4. The method of claim 1, further comprising:
generating a mapping user interface, a navigation user interface, or a combination thereof based on the output.

5. The method of claim 1, wherein the new point is determined as a halfway point between the first point and the second point.

6. The method of claim 1, wherein a position of the new point between the first point and the second point is determined based on the identifiable characteristic associated with the first point, the second point, or a combination thereof.

7. The method of claim 6, further comprising:
processing the identifiable characteristic associated with the first point, the identifiable characteristic associated with the second point, another characteristic of the first point or the second point, the one or more determined triangle edges, or a combination thereof using a machine learning model to determine the position of the new point between the first point and the second point.

8. The method of claim 1, wherein the plurality of codes includes a postal code, a height-profile code, a crime rate code, an air-pollution code, a noise code, a school district code, a flood zone code, a zoning code, an aerial image code, a taxi rate zone code, a subway rate zone code, a franchise territory code, or an electoral district code.

9. The method of claim 1, further comprising:
limiting query results to a spatial search based on the output.

10. The method of claim 9, wherein the spatial search is based on a navigation routing request, the method further comprising:
generating a navigation route based on the polygon; and
providing the navigation route for one or more vehicles.

11. The method of claim 10, wherein the one or more vehicles includes one or more delivery vehicles, one or more ride-sharing vehicles, or a combination thereof.

12. The method of claim 1, further comprising:
determining that the polygon is enclosed within another polygon as a hole of the another polygon;
providing a multi-polygon including the other polygon as a primary polygon and excluding the hole as a secondary polygon; and
including the multi-polygon in the output.

13. An apparatus comprising:
at least one processor; and
at least one memory including computer program code for one or more programs,
the at least one memory and the computer program code configured to, with the at least one processor, cause the apparatus to perform at least the following,
receive a plurality of points of a point cloud, wherein the points are geospatial points and are respectively associated with at least one code of a plurality of codes representing an identifiable characteristic;
tessellate the plurality of points to generate a plurality of triangles;
process the plurality of triangles to determine one or more triangle edges that connect a first point associated with a first set of one or more codes of the plurality of codes and a second point associated with a second set of one or more codes of the plurality of codes, wherein the first set is different from the second set;
for each of the one or more determined triangle edges, add a new point along the one or more determined triangle edge and generating a new edge from the new point to a centroid of a respective triangle;
determine a polygon based on the new edge generated for each of the one or more determined edges, wherein the polygon represents a border between the plurality of points associated with the first set and the plurality of points associated with the second set; and
provide the polygon as an output.

14. The apparatus of claim 13, wherein the apparatus is further caused to:
remove the centroid of the respective triangle from the polygon.

15. The apparatus of claim 13, wherein the apparatus is further caused to:
process the output to generate digital map data to represent the border in a geographic database.

16. The apparatus of claim 13, wherein the apparatus is further caused to:
generate a mapping user interface, a navigation user interface, or a combination thereof based on the output.

17. The apparatus of claim 13, wherein the new point is determined as a halfway point between the first point and the second point.

18. A non-transitory computer-readable storage medium carrying one or more sequences of one or more instructions which, when executed by one or more processors, cause an apparatus to perform:
receiving a plurality of points of a point cloud, wherein the points are geospatial points and are respectively associated with at least one code of a plurality of codes representing an identifiable characteristic;
tessellating the plurality of points to generate a plurality of triangles;
processing the plurality of triangles to determine one or more triangle edges that connect a first point associated with a first set of one or more codes of the plurality of codes and a second point associated with a second set of one or more codes of the plurality of codes, wherein the first set is different from the second set;
for each of the one or more determined triangle edges, adding a new point along the one or more determined triangle edge and generating a new edge from the new point to a centroid of a respective triangle;
determining a polygon based on the new edge generated for each of the one or more determined edges, wherein the polygon represents a border between the plurality of points associated with the first set and the plurality of points associated with the second set; and
providing the polygon as an output.

19. The non-transitory computer-readable storage medium of claim 18, wherein the apparatus is caused to further perform:
removing the centroid of the respective triangle from the polygon.

20. The non-transitory computer-readable storage medium of claim 18, wherein the apparatus is caused to further perform:
processing the output to generate digital map data to represent the border in a geographic database.
